(19) United States
(12) Patent Application Publication
(10) Pub. No.: US 2011/0313685 A1
(43) Pub. Date: Dec. 22, 2011

(54) SYSTEM AND METHOD FOR SAND DETECTION

(76) Inventors: Koen Geirnaert, Drongen (BE); Peter Staelens, Brugge (BE); Sebastien Deprez, Klerken (BE)

(21) Appl. No.: 13/173,402

(22) Filed: Jun. 30, 2011

Related U.S. Application Data
(63) Continuation-in-part of application No. PCT/EP2009/067934, filed on Dec. 24, 2009.

(30) Foreign Application Priority Data
Dec. 31, 2008 (GB) 0823649.9
Dec. 4, 2010 (GB) 1020546.6

(51) Int. Cl. G06F 19/00; G01N 3/30

(52) U.S. Cl. 702/41; 73/12.13

(57) ABSTRACT

A computerized system for obtaining information regarding a waterway is described. The system comprises an input means for receiving accelerometer data from an accelerometer of a free fall object and a processing means being programmed for deriving, based on said data accelerometer data at least one of a density, a viscosity or a depth of a soil. The present invention also relates to a free fall impact object comprising such a computerized system, to a method for obtaining information regarding a waterway and to corresponding computer related products.

### FIELD OF THE INVENTION

The invention relates to the field of soil structure detection and soil structure evaluation. More particularly, the present invention relates to methods and systems for detecting soil structure under a water column and for identifying layers of sand and to methods and systems for analyzing the soil structure under a water column, e.g. for determining the nautical bottom level of a waterway.

### BACKGROUND OF THE INVENTION

During the last decennia the off shore industry and in particular the dredging industry is growing significantly. This growth is partially driven by a new market for land creation. When creating land, huge amounts of sand are dredged, pumped and displaced on the spot of creation. Therefore, it is crucial to identify in the regional waters of the activity spots where sand can be dredged. Deployment of the equipment and time spent to find and gather sand often takes a big amount of the overall project time and financial budget. Reducing both time and economic cost on this part of the activity can lead to a significant return in efficiency. For example, it is not unrealistic that dredging companies gather sand on distances of more than 500 km away from the spot of operation. If by having the right detection equipment, sand might be found in an area of less than 100 km a significant increase in efficiency and cost can be obtained.

Different types of soil structure analysis equipment exist, often divided in two categories: non-intrusive equipment and intrusive equipment.

Examples of non-intrusive equipment are radioactive soil evaluation equipment and acoustic soil evaluation equipment such as parametric and standard sonar or seismic systems. Non-intrusive equipment typically may allow identifying regions with identical response rather than allowing identifying the type of material from the obtained data as such.

Examples of intrusive equipment are soil probe equipment and soil penetrometer equipment. One often used system for detection and/or analysis of the undersea soil structure is a free fall penetrometer. The penetrometer is often built of a cylindrical body with a conical top. In use, the device reaches a terminal velocity under free fall conditions in water and impacts the soil with this known velocity. Often pressure sensors and accelerometers are introduced on board of the free fall penetrometer. Measurement of the deceleration and pressure allows, upon processing of the signal, to find out the finger print of the soil type detected. An exemplary free fall penetrometer, as known from prior art, is shown in FIG. 1.

One of the drawbacks of penetrometers on the market is that they are less suitable for detection of sand layers, amongst others, sand layers covered by e.g. a layer of soft sediment.

Transport over water is becoming more and more important in a globalised economy. This results in more and bigger vessels and ships that need to enter harbors and inland waterways. Therefore the navigability of harbors and waterways need to be guaranteed. Deepening and widening of waterways and harbors is a constant activity done by authorities to ensure ships can pass and navigate. To determine the correct depth of the waterway and the dredging effort required, the physical parameters of the underwater soil structures need to be known.

In scientific terms the nautical bottom is the level where physical characteristics of the bottom reach a critical limit beyond which contact with a ship's keel influences the controllability and maneuverability.

To determine whether there is need to be dredged in order to make the waterway navigable, the characteristics or rheology of the underwater sediment and mud layers must be monitored and analyzed. The physical properties of the underwater sediment will influence the possibility of navigation through it or just above it). The properties and characteristics of the fluid and partially consolidated mud is a very complex issue. Most of the techniques to determine the nautical bottom are based on density information because of the relatively easy way of measuring.

Today mainly density is measured as indicator for the nautical bottom, where the critical threshold is often put on 1200 kg/m³. These measurements are done with different type of equipment based on tuning forks, radioactive sources, etc.

Besides deepening of waterways also the identification and classification of soil structures is of importance when constructing under water or to identify underwater resources. In the identification and classification process the physical characteristics of the fluid and partially consolidated mud are important.

### SUMMARY OF THE INVENTION

It is an object of the present invention to provide good impact devices and corresponding systems and methods for performing free fall penetrometry. It is an advantage of embodiments of the present invention that methods and systems are provided adapted for detection of sand layers, even when these are covered with a layer of soft sediment. It is an advantage of embodiments according to the present invention that the impact device can intrude sand layers or alternatively can intrude a top layer of soft sediment, e.g. mud, and at least part of a subsequent sand layer.

It is an advantage of embodiments according to the present invention that the systems are adapted in mechanical design so as to allow accurate penetration of sand layers and/or covered sand layers.

It is an advantage of embodiments according to the present invention that systems and methods are provided for characterizing the geotechnical parameters of surface sediments or mud layers on the soil.

It is an advantage of embodiments according to the present invention that the systems can be adapted in electronics design so as to allow accurate detection of sand layers and/or covered sand layers.

It is an advantage of embodiments according to the present invention that the systems are adapted for identifying sand layers and/or covered sand layers.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

The present invention relates to an impact device for detecting sand positioned under water, the impact device comprising a head adapted for, upon impact with soil under water, substantially penetrating into a layer of sand, and the impact device being adapted for obtaining, upon penetrating in or removal from within a soil structure, information for identifying whether the penetrated soil structure comprises a layer of sand. The head comprises a needle shaped portion having an average diameter between 0.5 mm and 5 mm and a more broad base portion of the head.

The needle-shaped portion may have a length to width ratio of at least 25 to 1.

The needle-shaped portion may have a length of at least 30 cm.

The needle-shaped portion and the base portion each may act separately with respect to each other upon impact with the soil structure.

The needle-shaped portion of the impact device may be disposable and the other part of the impact device may be re-used.

The needle-shaped portion of the impact device may be connected by wire with the remainder part of the impact device so as to be able to remove it from the soil if the needle-shaped portion has been broken from the remainder part of the impact device during impact with the soil.

The head may have a concave shape.

The impact device may comprise a fluid injector for injecting fluid from a fluid reservoir via the head into said soil during impact with said soil.

The fluid injector may comprise at least one inner portion movable in an outer shaft for inducing upon or during said impact pressure on a fluid in the fluid reservoir.

The at least one inner portion may be mounted on a spring in the impact device, the spring being adapted to provide a force on the at least one inner portion upon or during impact of the head of the penetrometer with the soil so as to increase the pressure on the fluid in the fluid reservoir.

The needle-shaped portion of the head may be provided with fluid openings in connection with the fluid reservoir.

The impact device may comprise at least one sensor for obtaining information for identifying whether the penetrated soil structure comprises a layer of sand.

The at least one sensor may comprise an accelerometer having a bandwidth of at least 5 G.

The impact device furthermore may be adapted with one or more of chemical sensor equipment, resistive measurement equipment, acoustic backscatter measurement equipment, shock and ultrasonic test equipment, optical backscatter measurement equipment, electromagnetic backscatter measurement equipment, measurement equipment based on a tuning needle system or measurement equipment based on a rotating needle.

The impact device furthermore may comprise a control means for controlling the speed, spin and torque of the penetrometer.

The impact device furthermore may comprise a data memory for receiving data from at least one sensor device and for storing said data.

The impact device furthermore may comprise an interface for connecting to a computing and/or displaying device once the impact device is recovered from under the water surface.

The impact device may be a free fall penetrometer.

The head of the impact device may comprise at least two needle-shaped portions.

The present invention also relates to a data processor for processing data for the detection of sand, the data processor being adapted for receiving information regarding penetration of or removal from within a soil structure obtained with an impact device adapted for penetrating into a sand layer and for processing said received information for determining presence or absence of a sand layer in the penetrated soil structure.

The data processor may comprise a means for deriving deceleration information for the impact of the impact device and the soil structure and deriving based thereon presence or absence of a sand layer.

The data processor may be adapted for detecting, based on the received information, a low amount of deceleration of the impact device stemming from penetration of a needle-shaped portion into a sand layer followed by an abrupt deceleration of the impact device stemming from an impact of a base portion of the head of the impact device, and determining, based thereon, that a sand layer is present in the soil structure.

The data processor may be adapted for taking into account a deceleration behavior due to a mechanical shape of the head of the impact device comprising a needle shaped portion and a base portion and/or for taking into account a deceleration behavior due to injection of fluid from the head into the soil upon impact.

The data processor may furthermore comprise a means for coupling position information regarding a position of the impact device impact device to the information regarding the type of soil structure obtained with the impact device.

The present invention also relates to a system for detection of sand layers under water, the system comprising at least a first impact device as described above and a data processor as described above.

The present invention furthermore relates to a system for detection of sand layers under water, the system comprising at least a first and second impact device, wherein at least one of the first and second impact device is an impact device as described above and wherein the first and second impact device are adapted for simultaneous use and are adapted for acting as a sender respectively receiver in a resistive, acoustic or electromagnetic measurement.

The present invention also relates to a method for detecting sand positioned under water, the method comprising
bringing an impact device comprising a head with a needle-shaped portion having an average diameter of 0.5 mm to 5 mm adapted for penetrating into a sand layer in free fall condition under the water surface, thus

inducing, upon impact with a soil structure under the water surface, penetration of a needle-shaped portion of a head of the impact device into the soil structure, and
obtaining, upon penetration in or removal from within the soil structure, information for determining the presence or absence of a sand layer in said soil structure.

The method may comprise inducing penetration of a needle-shaped portion of the head of the impact device into the soil structure.

The method may comprise injecting fluid from a fluid reservoir in the impact device via a head of the impact device into said soil during impact with said soil.

The method further may comprise deriving deceleration information for the impact between the impact device and the soil structure and deriving based thereon presence or absence of a sand layer.

The method may comprise detecting, based on the obtained information, a low amount of deceleration of the impact device stemming from penetration of a needle-shaped portion into a sand layer followed by an abrupt deceleration of the impact device stemming from an impact of a base portion of the head of the impact device, and determining, based thereon, that a sand layer is present in the soil structure.

The method may be adapted for taking into account a deceleration behavior due to a mechanical shape of the head of the impact device comprising a needle shaped portion and a base portion and/or for taking into account a deceleration behavior due to injection of fluid from the head into the soil upon impact.

The method may comprise capturing one or more of a chemical signal, resistive measurements signal, acoustic backscatter measurement signal, a shock and ultrasonic test signal, an optical backscatter measurement signal and an electromagnetic backscatter measurement signal.

The method further may comprise obtaining position coordinates associated with the position of the impact device and coupling the position coordinates with information regarding the soil structure obtained with the impact device.

The method furthermore may comprise simultaneously using a second impact device and using the impact devices as sender and receiver in a resistive, acoustic or electromagnetic measurement.

The present invention also relates to a computer program product adapted for, when run on a computer, receiving information regarding penetration of or removal from within a soil structure obtained with an impact device with a needle shaped portion of a head of the impact device having an average diameter of 0.5 mm to 5 mm adapted for penetrating into a sand layer and for processing said received information for determining presence or absence of a sand layer in the penetrated soil structure.

The computer program product may be adapted for deriving deceleration information for the impact of the impact device and the soil structure and deriving based thereon presence or absence of a sand layer.

The computer program product may be adapted for detecting, based on the received information, a low amount of deceleration of the impact device stemming from penetration of a needle-shaped portion into a sand layer followed by an abrupt deceleration of the impact device stemming from an impact of a base portion of the head of the impact device, and determining, based thereon, that a sand layer is present in the soil structure.

The computer program product may be adapted for taking into account a deceleration behavior due to a mechanical shape of the head of the impact device comprising a needle shaped portion and a base portion and/or for taking into account a deceleration behavior due to injection of fluid from the head into the soil upon impact.

The present invention also relates to a data carrier comprising a computer program product as described above and/or the transmission of such a computer program product over a network.

It is an advantage of embodiments of the present invention that the system may allow deep intrusion of soil layers. The latter can enable detection of sand layers on the bottom of water columns.

It is an advantage of embodiments according to the present invention that accurate detection of sand layers can be obtained. The high degree of accuracy can be, according to some embodiments, supported by electronic measurements of intrusion parameters.

It is an advantage of embodiments according to the present invention that advanced data analysis may assist in more accurate identification of sand layers.

It is an advantage of embodiments of the present invention that the cost of operation of the system can be low. The system can be made easy to handle, e.g. as it can be made small in size. The system according to some embodiments can be operated from a small vessel or rib.

It is an advantage of embodiments according to the present invention that methods and systems can be provided resulting in an easy, reliable and/or consistent operation. According to some embodiments, the robust design can assist in reliable operation. According to some embodiments, the impact device can be dropped in all directions and will adjust itself to the appropriate direction of impact.

It is also an object of the present invention to provide good impact devices, such as e.g. free fall penetrometers, and corresponding systems and methods for determining physical parameters of underwater soil structures, such as for example for determining the nautical bottom level. It is an advantage of embodiments according to the present invention that systems and methods are provided for determining physical parameters like density and shear stress of underwater soil structures. It is an advantage of embodiments according to the present invention that soil structure, soil type and nautical bottom can be derived from such parameters.

It is an advantage of embodiments of the present invention that methods and systems are provided adapted for analyzing the combination of physical parameters in parallel to determine the nautical bottom. It is an advantage of embodiments according to the present invention that the impact device can measure the critical depth in a full continuous measurement. It is an advantage of embodiments according to the present invention that the systems are adapted in mechanical design so as to allow penetration of the mud layers without disturbing or with minimal disturbance of the measured layer. It is an advantage of embodiments according to the present invention that the systems can be adapted in electronics design and specific in sensor integration to analyze the underwater mud layer and detect the nautical bottom.

It is an advantage of embodiments according to the present invention that determination of physical parameters is not only based on a relation between density and rheology. This more complete approach advantageously results in the possibility of obtaining a more complete picture of the nautical bottom level. It is an advantage that shear-strength, rigidity and viscosity also can be taken into account in methods and/or systems of embodiments according to the present invention, as these typically may have an important influence on the determination of the nautical bottom level.

It is an advantage of embodiments according to the present invention that the measurement is limited or not influenced by sediment thixotropy. Some non-Newtonian pseudoplastic fluids show a time-dependent change in viscosity, which can be more easily measured with embodiments of the present invention.

It is an advantage of embodiments according to the present invention that parameter such as required dredging power for dredging the different soil layers can be derived, as well as the nautical bottom of the waterway, the soil structure and the identification of the soil type.

The present invention also relates to a computerized system for obtaining information regarding a waterway, the system comprising an input means for receiving accelerometer data from an accelerometer on a free fall object, and a processing means being programmed for deriving, based on said data accelerometer data at least one of a density, a viscosity or a depth of a soil. It is an advantage of embodiments according to the present invention that a system is provided that allows obtaining accurate information regarding a nautical bottom level, soil level and/or soil structure of a waterway. It is an advantage of embodiments according to the present invention that an accurate determination of the nautical bottom level can be obtained. It is an advantage of embodiments according to the present invention that information regarding nautical bottom level, soil structure and/or soil type can be obtained using captured data during a continuous single falling path of the free fall object.

The processing means may be programmed for deriving at least the density based on said data. It is an advantage of embodiments according to the present invention that a processing means is provided allowing determining the nautical bottom level, which is an important level for navigation. It is an advantage of embodiments according to the present invention that information can be determined on a sudden point of the water way quickly, using a single measurement.

The processing means may be programmed for deriving the density based on the buoyancy force due to the displaced volume by the free fall object during its falling path in the liquid.

The processing means may be programmed for deriving the density based on an acceleration/deceleration of the free fall object, the buoyancy force due to the displaced volume and one or more of a drag force and a pore pressure.

The system may be adapted for co-operating with or comprising the free fall object and the processing means being programmed for taking into account mass information of the free fall object and information regarding at least one dimension of the free fall object. It is an advantage of embodiments according to the present invention that a system is provided that allows obtaining accurate information by calculation based on a number of parameters that can be measured using one or more sensors.

The free fall object may be an elongated object, and the processing means may be programmed for taking into account a side surface along the length of the elongated object for determining said at least one of a density, a viscosity or a depth of a soil. It is an advantage of embodiments according to the present invention that the system can use conventional free fall objects, such as for example free fall penetrometers. It is an advantage of embodiments according to the present invention that light weight free fall penetrometers can be used. It is an advantage of embodiments according to the present invention that free fall objects with a mass between 0.1 kg and 10 kg can be used.

The processing means may be programmed for taking into account a diameter of the free fall object. It is an advantage of embodiments according to the present invention that the diameter, e.g. the surface area of the top of the free fall object and thus a pore pressure thereon, can be neglected if the diameter to length ratio of the free fall object is smaller than 0.1, advantageously smaller than 0.05 or smaller than 0.01.

The processing means may be programmed for taking into account any or a combination of a volume, length, drag coefficient or friction coefficient of the free falling object.

The processing means furthermore may be programmed for taking into account a pressure measurement obtained with said free fall object and/or optical or mechanical sensor drag force measurements obtained with said free fall object. It is an advantage of embodiments according to the present invention that additional information can be taken into account for deriving any of the density, viscosity or depth.

A pressure sensor may be provided in a head of the free falling object for taking into account a pore pressure on the free fall object.

The processing means may be adapted for using said pressure or optical or mechanical sensor measurements for cross-checking, compensating or fine-tuning the obtained values of the density, viscosity or depth. It is an advantage of embodiments according to the present invention that the system can determine one or more of the density viscosity or depth based on said accelerometer data and that information of additional sensors can be used for cross-checking or fine-tuning results.

The processing means may be programmed for deriving a shear stress based on said optical or mechanical sensor measurements and for deriving said density, viscosity or depth based on said shear stress.

The system furthermore may be adapted for deriving a shear stress. It is an advantage of embodiments according to the present invention that density, viscosity, depth as well as shear stress can be determined during a single fall of the free fall object, resulting in an efficient system.

The free fall object may comprise an array of optical or mechanical sensors along the length of the free fall object, and the processing means being adapted for deriving a shear stress on the free fall object as function of velocity. It is an advantage of embodiments according to the present invention that not only shear stress can be determined, but that shear stress can be determined as function of velocity. It furthermore is an advantage of embodiments according to the present invention that shear stress as function of velocity can be obtained requiring only data for a single fall of the free fall object.

The computerized system may be a free fall object, whereby the input means and processing means are integrated in the free fall object. It is an advantage of embodiments according to the present invention that the different components required for obtaining accurate measurements of the nautical bottom level, the soil structure or soil type can be obtained with a single integrated system.

The free fall object also may comprise a transmission means for transmitting results to a position above the water surface of the waterway. It is an advantage of embodiments according to the present invention that results can directly be consulted on a position above the water surface of the waterway.

The processing means furthermore may be adapted for deriving one or more of a nautical bottom level, soil type or soil structure based on said density, viscosity and/or depth. It is an advantage of embodiments according to the present invention that information directly usable for evaluating navigation can be obtained.

The present invention also relates to a method for obtaining information regarding a waterway, the method comprising receiving accelerometer data from an accelerometer of a free fall object, deriving, based on said data accelerometer data at least one of a density, a viscosity or a depth of a soil.

Said deriving may comprise at least deriving the density based on said data. Said deriving may comprise deriving the density based on the buoyancy force due to displaced volume by the free fall object during its falling path in the liquid.

Said deriving may comprise deriving the density based on an acceleration/deceleration of the free fall object, the buoyancy force due to the displaced volume and one or more of a drag forces and a pore pressure. Deriving may comprise taking into account mass information and information regarding at least one dimension of the free fall object from which the accelerometer data are obtained. Deriving may comprise taking into account a side surface along the length of the free fall object used for determining said at least one of a density, a viscosity or a depth of a soil. Deriving may comprise taking into account a diameter of the free fall object. Deriving may comprise taking into account a pressure measurement obtained with the free fall object and/or optical or mechanical sensor measurements obtained with the free fall object. The method may comprise using the optical or mechanical sensor measurements for deriving a shear stress and determining from the shear stress any of the density, viscosity or depth for cross-checking the values of the density, viscosity or depth obtained using the accelerometer data.

The method furthermore may comprise deriving a shear stress based on the accelerometer data.

The method may comprise deriving a shear stress as function of velocity based on a single fall experiment of a free fall object.

The method may comprise transmitting the processed results from a processor on the free fall object to a position above the water surface of the waterway.

The present invention also relates to a free fall impact device for obtaining information regarding a waterway, the free fall impact device comprising an accelerometer for determining accelerometer data and a processing means being programmed for deriving, based on said data accelerometer data at least one of a density, a viscosity or a depth of a soil. The free fall impact device may comprise a computerized system as described above.

The present invention also relates to a computer program product adapted for, when run on a computer, performing a method as described above. The computer program product may be a web application.

The present invention also relates to a data carrier comprising a computer program product as described above and to the transmission of a computer program product over a network.

The present invention also relates to a free fall impact device for obtaining information about a waterway, the free fall impact device being an elongated free fall impact device and comprising an array of optical and/or mechanical sensors arranged along a length of the elongated free fall impact device. It is an advantage of embodiments according to the present invention that a system is provided allowing to derive shear stress as function of speed based on a single free fall experiment. The free fall impact device may comprise a processing means being programmed for deriving, based on data obtained from said array of optical and/or mechanical sensors and based on depth measurements correlated with said optical or mechanical sensor measurements, a shear stress as function of velocity. The free fall impact device furthermore may comprise a computerized system as described above.

The present invention also relates to a computerized system for obtaining information of a waterway, the computerized system comprising an input means for obtaining optical or mechanical sensor measurement data from an array of optical and/or mechanical sensors along a length of an elongated free fall object and depth measurement data, and a processing means being programmed for correlating said depth measurement data with said optical or mechanical sensor measurement data and for deriving, based on the correlated measurement data, a shear stress as function of velocity.

The present invention also relates to a computerized method for obtaining information regarding a waterway, the method comprising obtaining optical and/or mechanical measurement data from an array of optical or mechanical sensors along a length of an elongated free fall object and depth measurement data, correlating said depth measurement data with said optical or mechanical sensor measurement data, and deriving, based on the correlated measurement data, a shear stress as function of velocity.

The present invention also relates to a computer program product adapted for, when run on a computer, performing a method as described above. The computer program product may be a web application. The present invention also relates to a data carrier comprising such a computer program product and transmission of such a computer program product.

The present invention also relates to a free fall impact device for obtaining information about a waterway, the free fall impact device comprising a tuning fork mounted to a head of the free fall impact device for directly measuring a density during the falling path of the free fall impact device.

The present invention furthermore relates to a free fall impact device for obtaining information about a waterway, the free fall impact device comprising an array of resistance measurement elements for measuring a resistance of a sediment in the waterway during the falling path of the free fall impact device.

The present invention also relates to a free fall impact device for obtaining information about a waterway, the free fall impact device comprising at least two pressure sensors, wherein one pressure sensor is positioned in a head of the free falling impact device and one in a tail of the free falling impact device, for deriving a density based on a pressure difference measured between the at least two pressure sensors.

The present invention furthermore relates to a free fall impact device for obtaining information about a waterway, the free fall impact device comprising a sample capturing device for capturing a sample of a sediment during the falling path of the free fall impact device. The sample capturing device may comprise a sampler tube and a ball valve on the end of the sampler tube for keeping the sampled sediment in the tube upon retrieving the free fall device.

It is an advantage of embodiments of the present invention that the system may allow deep intrusion of mud layers. The latter can enable detection of critical layers on the bottom of water columns.

It is an advantage of embodiments according to the present invention that accurate detection of the soil type including of the nautical bottom can be obtained. The high degree of accuracy can be, according to some embodiments, supported by electronic measurements of intrusion parameters.

It is an advantage of embodiments according to the present invention that advanced data analysis may assist in more accurate identification of soil characteristics including the nautical bottom.

It is an advantage of embodiments of the present invention that the cost of operation of the system can be low. The system can be made easy to handle, e.g. as it can be made small in size. The system according to some embodiments can be operated from a small vessel or rib.

It is an advantage of embodiments according to the present invention that methods and systems can be provided resulting in an easy, reliable and/or consistent operation. According to some embodiments, the robust design can assist in reliable operation. According to some embodiments, the impact device can be dropped in all directions and will adjust itself to the appropriate direction of impact.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1—prior art shows a free fall penetrometer with a conical head as is known from prior art.

FIG. 2 shows a schematic drawing of an impact device with head adapted for intrusion in sand layers according to embodiments of the present invention.

FIG. 3 shows a particular example of an impact device with head adapted for intrusion in sand layers according to embodiments of the present invention.

FIG. 4 illustrates a schematic representation of wings as can be used on an impact device according to an embodiment of the present invention.

FIG. 5 illustrates an overview and detailed portion of an example of part of an impact device with needle-shaped portion as can be used according to a first particular embodiment of the present invention.

FIG. 6 illustrates different types of needle-shaped portions as can be used in a head of the impact device adapted for intrusion in sand layers according to embodiment of the present invention.

FIG. 7 shows an impact device with head adapted for intrusion in sand layers, the head comprising a concave shape, as can be used in embodiments of the present invention.

FIG. 8 shows an impact device comprising a head equipped with a fluid injection system for injecting fluid in the sand layers from a small fluid reservoir according to a particular embodiment of the present invention.

FIG. 9a and FIG. 9b show an impact device comprising a head equipped with a fluid injection system for injecting fluid in the sand layer from a large fluid reservoir respectively without and with separate sensor on the needle-shaped portion, according to a particular embodiment of the present invention.

FIG. 10 shows an impact device as shown in FIG. 8, wherein the needle-shaped portion is adapted with fluid openings so as to allow fluid injection from the needle in the sand layers. In the different drawings, the same reference signs refer to the same or analogous elements.

FIG. 11a illustrates an impact device with a resistivity measurement equipment according to an embodiment of the present invention.

FIG. 11b illustrates an impact device with a piezo-electric transducer for evaluating mechanical behavior in situ according to an embodiment of the present invention.

FIG. 11c illustrates an impact device with a rotatable needle, according to an embodiment of the present invention.

FIG. 12 illustrates an example of an impact device with integrated computerized system, according to an embodiment of the present invention.

FIG. 13 shows a force model on an impact device, as can be used in an embodiment of the present invention.

FIG. 14 illustrates a theoretical deceleration and speed curvers, as can be used in an embodiment of the present invention.

FIG. 15 illustrates a velocity profile of an in situ measurement of 10.5 m depth, as can be obtained using an embodiment of the present invention.

FIG. 16 illustrates the energy loss measurements of a free fall device of an in situ measurement, as can be obtained using an embodiment of the present invention.

FIG. 17 illustrates a density profile made up based on a Reynolds formula, as can be used according to an embodiment of the present invention.

FIG. 18 illustrates an free fall device comprising a pressure sensor for determination of the depth and density of the penetrated layers, according to an embodiment of the present invention.

FIG. 19 illustrates an free fall device comprising a tuning fork, according to an embodiment of the present invention.

FIG. 20 illustrates an free fall device comprising a rotating element to measure soil resistance, according to an embodiment of the present invention.

FIG. 21 illustrates an free fall device comprising a shear stress sensors, according to an embodiment of the present invention.

FIG. 22 illustrates an free fall device comprising a resistive measurement system, according to an embodiment of the present invention.

FIG. 23 illustrates a free fall device comprising a sampling means for sampling, according to an embodiment of the present invention.

FIG. 24 illustrates an example of two velocity curves determined using accelerometry and pressure sensor measurements and from which density can be determined, illustrating features and advantages of embodiments according to the present invention.

FIGS. 25(a) and (b) illustrates the acceleration and velocity as function of depth as obtained through accelerometric measurements, according to embodiments of the present invention.

FIGS. 26(a) and (b) illustrates the density and shear stress as function of depth as obtained through calculation of the losses of the instrument, according to an embodiment of the present invention.

FIG. 27 illustrates the viscosity as function of depth as derived from the speed and the shear stress, according to an embodiment of the present invention.

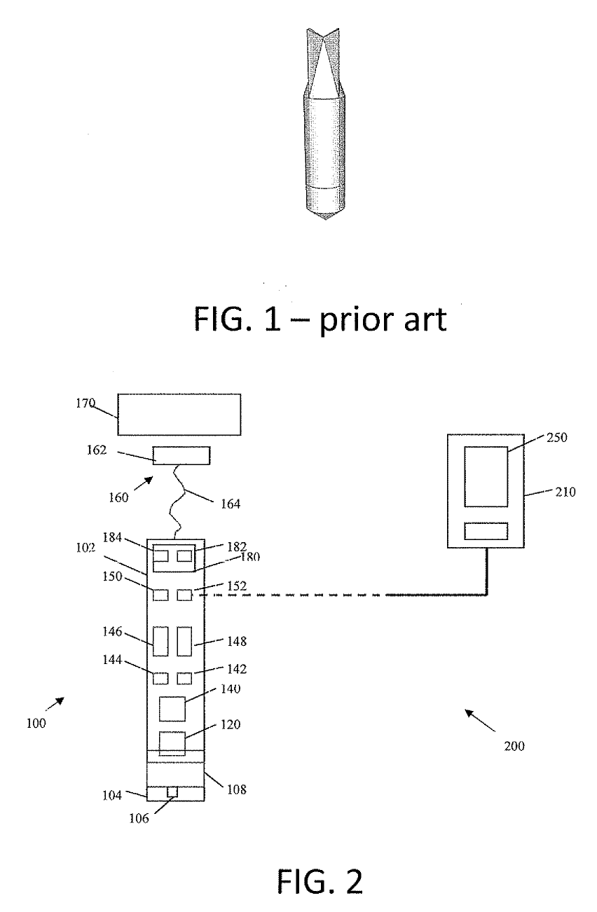

The drawings are only schematic and are non-limiting. In the drawings, the size of some of the elements may be exaggerated and not drawn on scale for illustrative purposes.

### DETAILED DESCRIPTION OF ILLUSTRATIVE EMBODIMENTS

By way of illustration, the invention will now be described in more detail. Reference will be made to different embodiments of the invention and to drawings indicating different parts of the invention, the invention not being limited thereto. The drawings are only schematic and are non-limiting. In the drawings, the size of some of the elements may be exaggerated and not drawn on scale for illustrative purposes. Any reference signs in the claims shall not be construed as limiting the scope. In the claims, the word “comprising” does not exclude other elements or steps, and the indefinite article “a” or “an” does not exclude a plurality. A single element may fulfill the functions of several items recited in the claims, unless stated otherwise. Variations different from the disclosed embodiments can be understood and effected by persons skilled in the art in practicing the claimed invention, from a study of the disclosure, drawings and the appended claims. The mere fact that certain measures are recited in mutually different dependent claims does not indicate that a combination of these measures cannot be used to advantage.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be understood that the terms used in embodiments of the invention described herein are capable of operation in other orientations than described or illustrated herein.

Where in embodiments according to the present invention reference is made to a waterway, reference is made to a navigable body of water, such as a river, channel, canal, sea, lake or ocean.

Where in embodiments according to the present invention reference is made to “nautical bottom” or “nautical bottom level”, reference is made to the depth where physical characteristics of the bottom of a waterway reach a critical limit beyond which normal navigation is not possible. The nautical bottom can be defined as the level where physical characteristics of the bottom reach a critical limit beyond which contact with a ship's keel influences the controllability and maneuverability.

Where in embodiments according to the present invention reference is made to “soil structure” and “soil type” or “soil type identification”, reference is made to the classification of the soil type based on the physical parameters of the measured soil. Based on for example the density, shear stress, viscosity and other physical parameters a soil type can be identified.

Where in embodiments according to the present invention reference is made to an accelerometer, reference is made to a device adapted for determining acceleration or deceleration of an object.

Where in embodiments according to the present invention reference is made to shear stress, reference is made to stress applied parallel or tangential to a face of a material.

Where in embodiments according to the present invention reference is made to density, reference is made to typical levels that are used in harbors to determine the nautical bottom. The nautical bottom is set on the depth where the mud reaches a density level of 1200 kg/m³.

Where in embodiments according to the present invention reference is made to a soil type identification, reference is made to the classification of the soil type based on the physical parameters of the measured soil.

In a first aspect, the present invention relates to an impact device for detecting sand positioned under water. The device may be particularly adapted for detecting layers of sand or layers of sand covered by a layer of soft sediment, e.g. undrained soft sediment. Such cover layers may for example be layers of mud, the invention not being limited thereto. The device may for example be used to distinguish layers of sand from sand-like layers, such as for example sandstone. The system may for example also be advantageous to distinguish layers of sand from other layers having an acoustic fingerprint similar as that of a sand layer. The impact device according to embodiments of the first aspect of the present invention may be a penetrometer, such as for example a free fall penetrometer. The impact device according to embodiments of the first aspect may comprise a head being adapted for substantially penetrating into a layer of sand upon impact with soil under water. The head thereby comprises a needle-shaped portion having an average diameter between 0.5 mm and 5 mm and a more broad base portion of the head. Such penetration may for example be over at least 10 cm, more advantageously at least 30 cm, or over at least 50 cm in a sand layer. According to embodiments of the present invention, the impact device is adapted for providing, upon penetration in or removal from within a soil structure, information for identifying whether the penetrated soil structure comprises a layer of sand. It is an advantage of embodiments according to the present invention that systems and methods are provided allowing substantial penetration of sand layers and/or covered sand layers so as to accurately detect the presence of sand layers. Such penetration may be without tools external to the impact device. Sand is a granular medium, acting as a hard and stable layer. According to embodiments of the present invention, the head of the impact device may be adapted in mechanical design so as to allow substantial penetration in a variety of ways, such as for example by providing a particular shape of the head, by providing a fluid injector adapted for injecting fluid via the head upon impact with the soil, in any other suitable way or by combination of these adaptations. It is an advantage of embodiments of the present invention that the systems and methods allow intrusion and detection of sand. It is an advantage of embodiments of the present invention that the systems and methods allow identification of a covered sand layer. It can for example be identified if a layer of sand is present whereon cementation has occurred or whereon a matrix is present. It can be distinguished if a clay matrix is present (sand does not behave inter-granular), if a calcite, aragonite or silica matrix is present as this makes from sand a sandstone (on which e.g. a needle will bend or break), etc. It is an advantage of embodiments of the present invention that sand layers with value can be distinguished from sand layers without value.

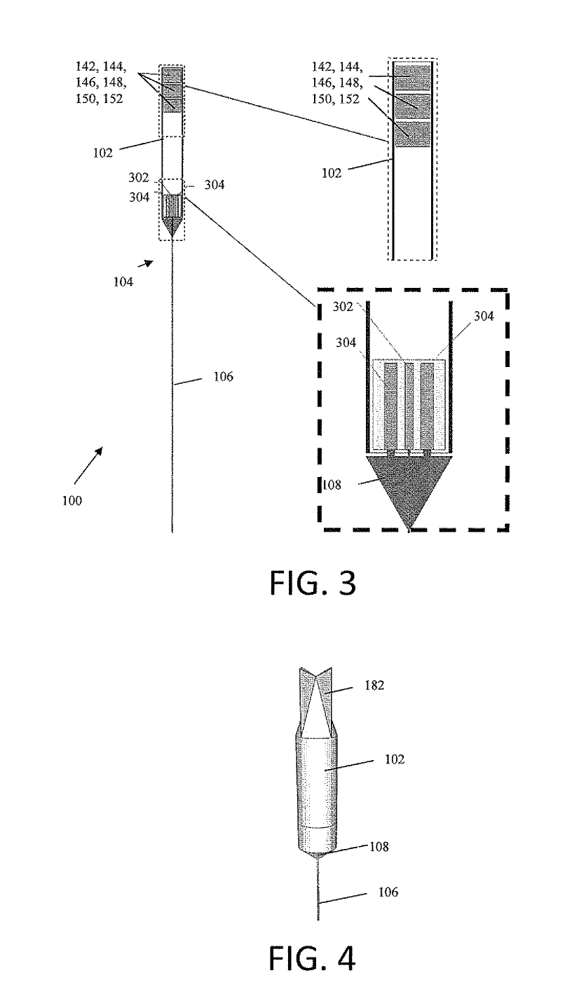

By way of illustration, the present invention not being limited thereto, standard and optional components of the impact device according to embodiments of the present invention are discussed in more detail, with reference to FIG. 2 and with reference to one exemplary embodiment shown in FIG. 3.

FIG. 2 illustrates an impact device 100 for detecting sand positioned under water. The impact device may more particularly be a free fall penetrometer, although the invention is not limited thereto. The impact device 100 comprises a head 104 and optionally a distinguishable body 102. FIG. 3 shows an exemplary embodiment of such an impact device 100.

The optional body 102 may have any suitable shape. It may for example be cylindrically or tubular shaped, although the invention is not limited thereto. The body 102 may be made of any suitable material such as composites, any kind of alloy, inox, lead, etc. The body 102 may be adapted for carrying the electronics for operating sensors on board of the impact device 100. The latter is e.g. illustrated schematically in FIG. 2 and in FIG. 3 in the enlarged view of the body 102 comprising optional electronic components 142, 144, 146, 148, 150, 152, as will be discussed further. The mass of the impact device advantageously is selected to induce an appropriate impact. It may for example be in a range between 5 kg and 25 kg, embodiments of the invention not being limited thereto. The size of the body 102 may be adapted to the components it carries. In some embodiments, the average diameter of the body 102 in a direction perpendicular to the intended direction of impact may be between a couple of centimetre and up to 50 cm. The body may be adapted for receiving additional weights, such as for example cylindrical lead blocks, for making the device heavier.

The head 104 according to embodiments of the present invention is adapted for allowing substantial penetration into a layer of sand. The impact device 100 furthermore may be adapted for obtaining, upon penetration in or removal from within a soil structure, information for identifying the presence or absence of a layer of sand in the soil structure. The information may be obtained during impact or upon removal of the impact device. The penetration and the fact that information regarding the presence of a sand layer will be obtained by the impact device, can be established in a variety of ways, for example by adjusting the head in mechanical shape so that it comprises a needle-shaped portion, by adjusting the head in mechanical shape so that it comprises a needle-shaped portion 106 on a more broad base portion 108, by adjusting the head in mechanical shape so that it has more generally a concave shape, by adapting the head with a fluid injector 120 system, in other ways or by a combination of any of these. By way of example FIG. 3 illustrates a head 104 with a needle shaped portion 106 and a broader base portion 108, the invention not being limited thereto. A more detailed description of different adaptations will be provided in different particular embodiments described later.

In one example, the system may be adapted for obtaining information regarding the presence of a sand layer in the penetrated soil structure in that it comprises at least one sensor 140, which in combination with the possibility for substantial penetration of the sand layer, allows for sensing information adapted for identifying whether a layer of sand is indeed present. Such at least one sensor 140 may be a plurality of sensors. The at least one sensor 140 may comprise at least one shear force sensor (friction sleeve) for allowing measurement of shear forces and/or shear resistance on the head 104 or components thereof or on the body 102 during penetration of the one or more soil layers. Alternatively or in addition thereto, the at least one sensor 140 may comprise at least one accelerometer for measuring deceleration upon impact of the impact device 100. Alternatively or in addition thereto, the at least one sensor 140 may comprise at least one pressure sensor for measuring pressure on the head 104 and/or the body 102 during impact of the impact device 100. As the system is adapted for substantially penetrating sand layers, the at least one sensor advantageously may be adapted to be compatible with a relative slow deceleration of the head 104 in a sand layer. It will be clear that the body of the penetrometer itself will decelerate rapidly. The bandwidth of the at least one sensor therefore may be adapted to such a slow deceleration in a sand layer. For example, if an accelerometer is provided, the bandwidth of the accelerometer provided may be at least 5 G, and may range up to 100 G. The latter allows a more reliable measurement. In FIG. 3 the at least one sensor 140 comprises, by way of example, a separate sensor 302 for measuring impact on the needle-shaped portion 106 and separate sensors 304 for measuring impact on the broader base portion 108.

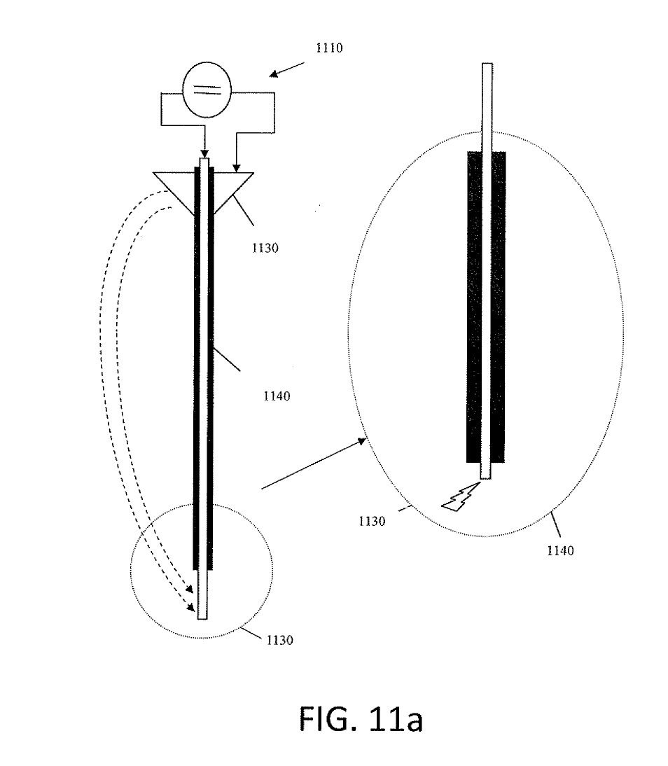

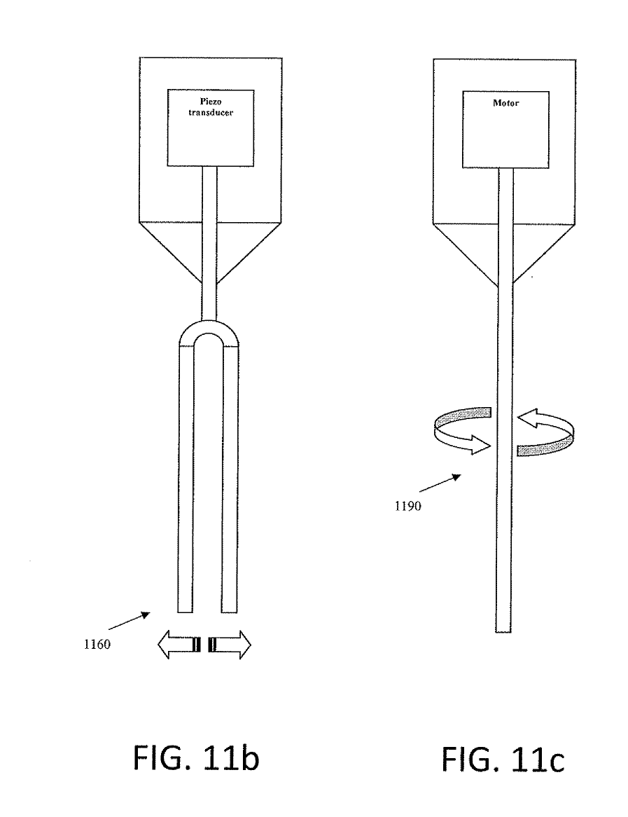

Alternatively or in addition to the above types of sensors, in one embodiment, the impact device 100, also may be adapted for providing information for identifying whether or not a layer of sand is present in the penetrated soil, by being adapted for obtaining information regarding the pull up shear stress when the impact device is recovered, i.e. pulled up, from out of the soil. Such adaptation may be with at least one sensor for obtaining pull up shear stress information which may be positioned on board or off board of the impact device 100. The sensor may for example be positioned at that side of the wire or rope for pulling up the impact device that is not connected to the impact device, but e.g. present on a boat. According to some embodiments of the present invention, the number of sensors can be limited, in order to increase robustness and simplicity of the device so as to reduce the number of components that may fail. The at least one sensor 140 furthermore may comprise a sensor for chemical analysis of layers of soil, e.g. of a covering layer of soil covering a sand layer. The at least one sensor 140 furthermore may be adapted for providing additional information such as for example it may comprise one or more of chemical sensor equipment, pressure equipment, resistive measurement equipment, acoustic backscatter measurement equipment, shock and ultrasonic test equipment, optical backscatter measurement equipment, electromagnetic backscatter measurement equipment. Shock and ultrasonic test equipment may comprise piezo-elements. This list of further measurement equipment is not exhaustive, but only provided by way of example. In one example equipment is provided for performing soil resistive measurement from the needle top or close thereto to the body. The latter can assist for identifying the material type. Using e.g. a schlumberger method, a wenner method or dipole-dipole method, different types of soils can be distinguished based on their resistivity. For example, sand has a typical resistivity between 1000 and 10000 ohm.m while clay has a resistivity between 10 and 100 ohm.m. Measurement of the resistivity thus can assist in identifying the material type. The resistivity measurement equipment may for example be obtained by providing an electrically insulating coating on the major part of the needle such that the needle is non-conductive over the major part of the surface and only conductive at the top. In this way a resistivity can be measured between the top of the needle and the base portion, e.g. using a DC voltage source. An example of part of such a set up is illustrated in FIG. 11a, also indicating an enlarged view of the needle top portion. A voltage source 1110 is shown for determining a voltage difference between the needle top 1120 and the surface of the base portion 1130. An electrically insulating coating 1140 also is indicated. In another example, piezoelectric transducers or electrical actuators are applied to evaluate the mechanical behavior in situ. A vibration via a piezo-electrical actuator is induced on e.g. a single needle system, a dual needle tuning fork, etc. and the damping and or frequency shift can be monitored for providing information of the material in between or near the needle(s). An example of such a system is illustrated in FIG. 11b, indicating a piezo-electrical transducer 1150 and a double needle structure 1160. In some embodiments, the needle also can be rotated, e.g. using a motor. In one example, the needle is rotated by a small motor on board of the penetrometer and the torque of the motor can be measured and is indicative of the resistance on the surface of the needle by the penetrated material. The resistance can be a measure of the material type and has a particular characteristic for sand. An example of such a system with rotatable needle is illustrated in FIG. 11c, indicating a motor 1180 and a rotating needle 1190.

Combined measurements may result in complementary information being available. For example, combination of the information obtained allowing identifying sand layers with acoustic measurement information may result in rapid identifying of larger areas of sand. It thereby is an advantage that one or more of these measurements may be performed during the same impact measurement as the gathering of the information for identifying soil as sand or covered sand. The latter results in a more efficient identification tool. The at least one sensor 140 advantageously comprises high speed and high accurate multi-channel sampling electronics. The sensors and the driving electronics thereof advantageously are positioned so that the corresponding electronic circuit board is as narrow as possible.

Advantageously, the impact device 100 optionally may comprise on board or off board of the body 102 one or more amplifiers 142 for amplifying the signals sensed by the at least one sensor 140.

Optionally, the impact device 100 may comprise separate buffers 144 for buffering the obtained sensor results. Buffering also may be performed in the amplifiers. The latter may be especially suitable when a plurality of sensors are applied and/or when sensor results are at least partly processed on board.

Optionally, the impact device 100 may comprise at least one controller 146, for example a microcontroller, for controlling sensing by the sensors and/or for controlling the data flow of the sensed data on board of the body 102 or the head 104. The at least one controller 146 may be adapted for controlling the measurement timing and sampling by the at least one sensor 140. The controller 140 may be adapted to generate a time stamp for measurement results obtained with the at least one sensor. The controller may be adapted for on board processing, although the invention is not limited thereto. In such cases, part or all of the tasks of the data processor as will be described later, also may be performed on board by the controller. Optionally, the impact device 100 may comprise a memory 148 for storing obtained data. The size of the memory 148 may be selected so that a plurality of measurements can be performed without the need for pulling the impact device 100 completely out of water, so that a large area can be sampled with the impact device 100 and the impact device only needs to be pulled up to a level above the soil surface allowing sufficient impact force on the soil surface. The latter thus results in the possibility to keep the body and head of the impact device 100 under water and to only lift it up till the altitude level that guarantees the limit speed, which may in the order of about 10 meter above the seafloor.

Optionally the impact device 100 may comprise a power source 150 for powering different components of the impact device 100. Such a power source 150 may for example be a battery. Alternatively or in addition thereto, on board power also may be induced by a fan being present on the impact device 100.

Advantageously, the impact device 100 optionally may comprise an interface 152 for retrieving the obtained information from the impact device. The interface 152 may be any suitable interface, such as for example a USB interface, an Ethernet interface, a serial bus interface, a wireless interface, etc. The interface 152 may allow transfer of data with a computing device for retrieving information such as sensor data or optionally processed sensor data when processing has already been at least partly performed on board. The information may be transferred to a computing and/or displaying device 210, which may be part of the impact system 200. Such a computing and/or displaying device 210 may be a personal computer such as for example a laptop, desktop, pda, printer or plotter, display or the like, the present invention not being limited thereto. The computing and/or displaying device 210 may comprise a data processor 250 adapted for identifying, based on the obtained information, the type of soil structure. It furthermore may be adapted to determine the thickness of the layers detected, an estimated volume of soil material of a given type, etc. The data processor 250 may be programmed for identifying soil as a sand layer or covered sand layer taking into account penetration of the head 104 of the impact device 100 and the obtained information. The data processor 250 may be programmed so as to take into account a particular mechanical design of the head 104 of the impact device 100 and/or fluid injection, as will be illustrated later. For example, in case an impact device with a needle-shaped portion and with a base portion is used, the data processor 250 may take into account that the deceleration will be based on a dual impact mechanism and may use this to identify a type of soil structure that is probed, An impact effect also can be induced by the inner body movement during fluid injection. The data processor 250 also may be adapted to take into account the change in deceleration stemming there from. When fluid injection is combined with a head having a needle-shaped portion on a broader base portion, a triple impact effect may occur, one from impact of the needle-shaped portion, on from the backlash from the injection and one from the impact of the base portion. The data processor 250 will be described in more detail below. The data processor 250 also may be adapted for receiving positioning information during the time of measurement, e.g. captured on the boat from which the impact measurements are performed, so as to allow coupling of positioning information to the information obtained in the impact device upon impact or upon pulling up of the impact device. Typically, synchronization may be performed. The positioning information may be obtained using a global positioning system, the invention not being limited thereto. Combination of positioning information and obtained information of the impact device or a processed version thereof allows providing geographical information regarding properties of the soil structure for which measurements are performed.

The impact device 100 furthermore optionally may be adapted with a winching system 160 for winching up the impact device 100 after impact has been finished. Such a winching system may be any winching system as used in existing free fall penetrometer devices, although the invention is not limited thereto. It may typically be provided partly on a boat assisting for performing impact measurements. It may for example comprise a spool 162 for carrying a cable, wire or rope 164 connected to the body 102 of the impact device 100 and able to release the cable, wire or rope 164 during free fall of the impact device 100 and for winding the cable, wire or rope 164 during pulling up of the impact device 100. Alternatively, the impact device is operated using only a cable, wire or rope, without necessarily requiring a full winching system 164.

The impact device 100 or the impact system 200 comprising the impact device 100 may optionally comprise a launching system 170 for launching the body 102 and head 104 of the impact device for impact with a soil structure, although embodiments of the present invention are not limited thereby. Such a launching system 170 may be any suitable system, in some embodiments for example being launching systems as used in prior art.

On the body 102, the impact device 100 may comprise a control means 180 for controlling the speed, orientation and/or spin of the impact device 100. At the end portion, opposite to the head 104, fins 182 for more easily obtaining an appropriate free fall direction of the impact device 100 may be present. Such fins 182 thus may assist in more easily obtaining a direction of the impact device 100 wherein the head 104 is directed towards the soil structure to be studied. In one embodiment, the invention not being limited thereto, the fins may comprise four wings, as shown in FIG. 4 by way of example. The impact device 100 also optionally may comprise flaps 184 for further controlling the speed, torque and/or spin of the impact device 100, although the invention is not limited thereby.

By way of illustration, the invention will now be further described with reference to a number of particular embodiments, the invention not being limited thereto.

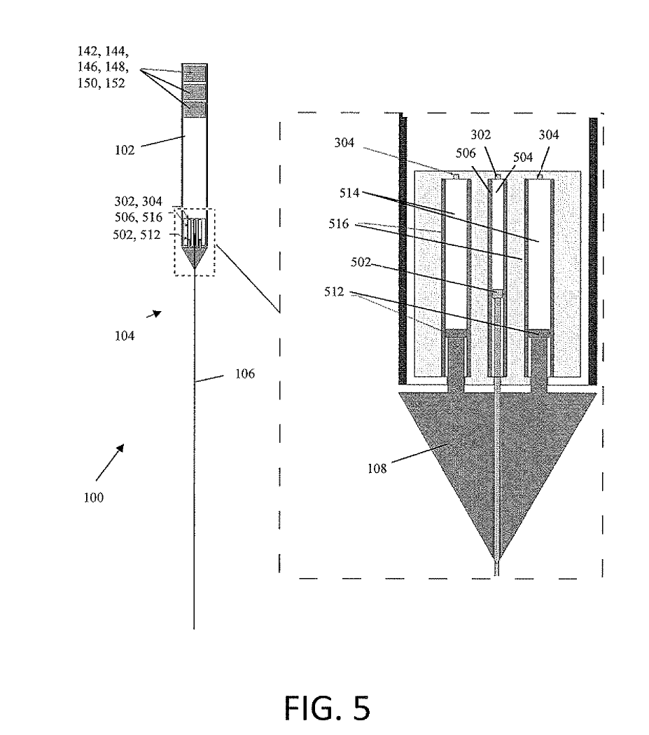

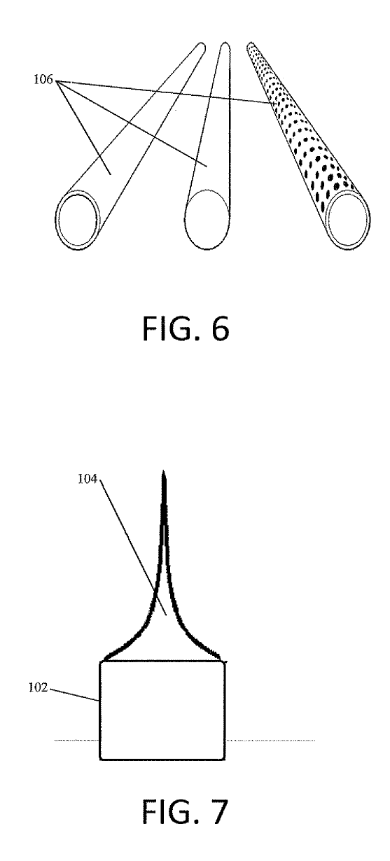

In a first particular embodiment according to the first aspect, the present invention not being limited thereto, an impact device 100 comprising standard features and optionally also optional features as indicated above is described, whereby the head 104 is adapted for substantially penetrating into a layer of sand by its mechanical design. According to the first particular embodiment, the head comprises a needle-shaped portion 106 and a broader base portion 108. The width of the impact device or portions thereof thereby is defined as sizes in the direction perpendicular to the direction of propagation and impact under free fall conditions of the impact device. An example of part of an impact device according to the first particular embodiment is shown in FIG. 5, the invention not being limited thereto. FIG. 5 illustrates an overview of an example of an impact device according to the first particular embodiment of the present invention, with a detailed view of the base portion and the sensor setup for the particular example. By using a needle-shaped portion 106, embodiments according to the present invention can result in a more efficient and deeper penetration in a sand layer, thus allowing more accurate detection of the sand layers and more accurate estimation of a volume of sand being present, even if covered under a layer of undrained soft sediment, such as for example mud. The needle-shaped portion may be made of any suitable material. The material advantageously is a very strong material, so as to reduce the chance of splintering of the material upon impact as much as possible. Some materials that could be used are composites, inox, steel, titanium, platinum, wood, etc. According to some examples, the needle-shaped portion may have a length within the range 1 cm to 100 cm, advantageously within a range having a lower limit of 1 cm, or 5 cm, or 15 cm or 30 cm and an upper limit of 35 cm or 50 cm or 70 cm or 100 cm. It is an advantage of embodiments according to the present invention that a length of the needle-shaped portion can be selected as function of the application, e.g. as function of the depth over which one wants to probe the soil. The average diameter of the needle-shaped portion may be of the same order of magnitude as the grain size of sand. Typically, sand grains vary in diameter between 0.05 mm and 2 mm. Anything with a lower diameter is silt, with a diameter typically between 0.05 mm and 0.004 mm or clay, with a diameter typically smaller than 0.004 mm, while larger diameters relate to gravel, having a diameter typically between 2 mm and 64 mm. The average diameter of the needle-shaped portion may be within the range of 0.5 mm to 5 mm, over at least 50%, advantageously at least 75%, more advantageously at least 90% of the length of the needle shaped portion. It is an advantage of embodiments according to the present invention that the needle-shaped portion can be selected to have a diameter in the order of the diameter of the sand grains, so that the sand medium will no longer act as a uniform hard granular body. The sand grains thus may interact on a more individual base with the needle-shaped portion allowing easier penetration of that portion. In some embodiments, the needle-shaped portion may have a length to width ratio of at least 25 to 1, or advantageously at least 50 to 1. The length to width ratio of the needle shaped portion may for example be around 500 to 1. The width of the needle-shaped portion 106 thus may be substantially smaller than the base portion 108 of the head 104. By way of illustration, examples of needle shaped portions 106 as can be used in embodiments according to the present invention are shown in FIG. 6. The examples shown illustrate a hollow needle-shaped portion, a solid needle-shaped portion, or a needle-shaped portion with fluid holes, as will be usable in a fourth particular embodiment of the present invention.

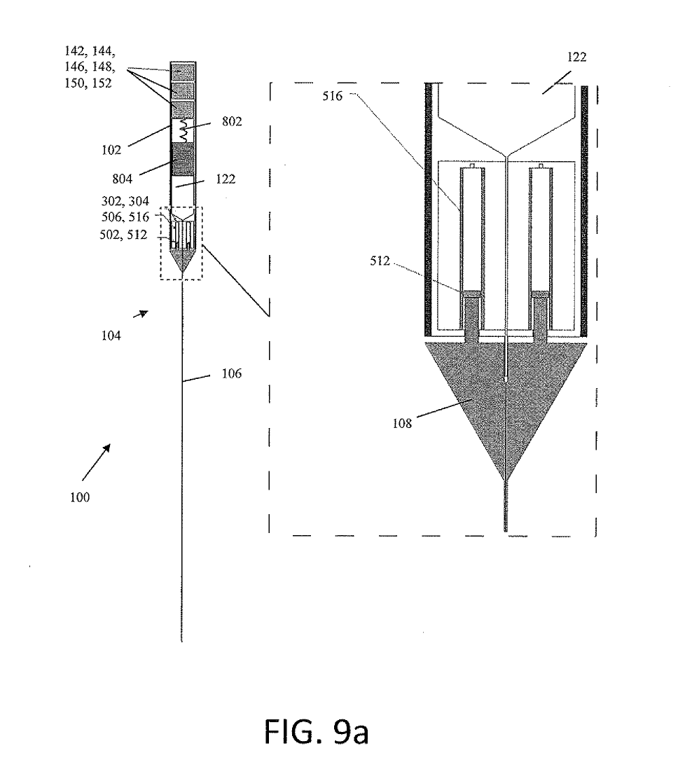

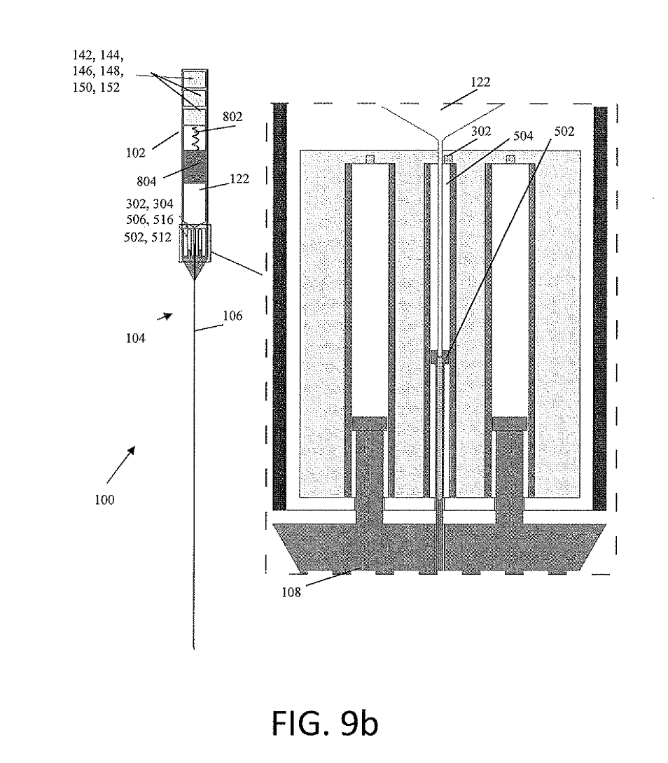

The needle-shaped portion 106 may be positioned in front of the base portion 108, i.e. so that the needle-shaped portion 106 reaches the soil structure before the base portion 108 when in appropriate free fall orientation. It may be positioned discrete from the base portion 108. In other words, upon impact, the needle-shaped portion 106 may behave substantially independent from the base portion 108. An example thereof is shown in FIG. 5. According to such an embodiment, the needle behaves as an extremely thin free fall penetrometer, sitting on a more conventionally sized penetrometer. The pressure or resistance on the needle-shaped portion 106 can be measured providing information for identifying a type of soil layer, e.g. as a sand layer. According to such an embodiment, typically a separate pressure, deceleration or resistance sensor may be provided for the discrete needle-shaped portion 106. In the present example, a sensor result is obtained for the needle-shaped portion 106 being in connection with a piston 502 in a shaft 504 and increasing the pressure in the shaft 504 upon impact of the needle-shaped portion 106 with the soil structure, which can be measured with a pressure sensor 302. Alternatively, the needle-shaped portion 106 may not be mounted as a discrete portion but is fixedly mounted to the base portion 108. The latter will be illustrated later for a different embodiment with reference to FIG. 9a and FIG. 9b. The needle shaped portion may be a disposable that is left in the soil structure, whereas the remaining portion can be re-used. According to some embodiments, the needle-shaped portion 106 may be connected by wire to the body or base portion, so that upon pulling up the impact device 100, the needle-shaped portion is removed from the soil structure. The latter assists in reducing or avoiding waste from being left at the soil structure.

The outer surface of the base portion 108 may have a substantially conical shape or any other suitable shape such as a tip with a predetermined angle, a flat head (e.g. suitable for soft mud) and adapted at the position where the needle shaped portion is placed. Sensors for measuring the impact of the base portion, discrete from or in combination with the needle-shaped portion, typically may be provided. The latter also is illustrated in FIG. 5, showing an example wherein for a base portion 108 discrete from the needle-shaped portion, two pressure sensors 304 for measuring the impact of the soil structure with the base portion 108 are provided. In the present example, upon impact of the soil structure with the base portion 108, pistons 512 are moved in shafts 514, inducing a pressure increase in the shafts 514 and allowing obtaining sensor results with pressure sensors 304. It will be obvious to persons skilled in the art that alternative sensor setups also can be provided. In the exemplary sensor setup, furthermore also shear resistance sensors 506, 516 are provided for measuring the shear resistance stemming from the needle-shaped portion 104 and for measuring the shear resistance stemming from the broader base portion.

The total length and weight of the body in the present embodiment may be selected as function of the needle length, as the body will have the lead weights in it and as this will determine the kinetic energy available for impact and therefore for penetration in the soil structure. In one embodiment, the head may be provided with at least two needle-shaped portions. The head may comprise a multiple of needle-shaped portions. One of the needle-shaped portions then may act as a sender and the other or others may act as a receiver in for example a resistive, acoustic or electromagnetic measurement. Examples thereof also have been given above.

Whereas the above particular embodiment has been described with reference to an in particular needle shaped portion, the present invention also encompasses embodiments wherein the mechanical shape of the head is at least substantially sharper than a cone, i.e. wherein the head of the device has a substantially concave shape. By way of illustration, FIG. 7 illustrates a possible shape of a concave shaped head of the impact device. It will be clear to the person skilled in the art that a head comprising a base portion and a needle-shaped portion positioned in front thereof, fulfill this concave shape requirement.

In a second particular embodiment, the present invention relates to an impact device 100 as described in the first particular embodiment, but wherein the impact device is completely needle-shaped, without broader portion e.g. without other body portion. The body and head are then formed by the same needle-shaped portion. Typically in such embodiment, no sensor may be on board, but the sensor may be positioned at the other side of the pull-back rope or wire, allowing to measure pull back shearing stress of the impact device when removed from the soil structure. The average diameter of the impact device may (for its complete length) be limited to between 0.5 mm and 5 mm. The needle-shaped impact device may be filled with heavy material in order to make it heavier and in order to assist the impact device in obtaining appropriate orientation under free fall conditions. Such material may for example be lead. The portion closer to the tip of the impact device, intended to have the first impact with the soil structure, may be made heavier than the portion of the impact device at the opposite side. Wings may be provided, as described above. Other features and advantages regarding the use of a needle-shaped device may be as set out for the needle-shaped portion in the first particular embodiment.

In a third particular embodiment, the present invention not being limited thereto, an impact device 100 comprising standard features and optionally comprising optional features as described in the general description of the first aspect or in the first particular embodiment as indicated above is described, whereby the impact device 100 comprises a fluid injector 120 for injecting fluid from a fluid reservoir 122 via the head into the soil during impact with the soil. It thereby is an advantage that upon injection of the fluid, the pore pressure in the sand can be increased, thus decreasing the contact pressure of the grains in sand and allowing a more easy penetration than without fluid injection. The head thus is adapted for substantially penetrating in a sand layer, as it will provide fluid channels for injection of fluid into the soil. The fluid used may be any suitable fluid such as for example, compressed gas, compressed air, liquid. The fluid injector 120 can take any suitable form, such as for example a recipient filled with compressed air that may be released with a pressure switch and/or that may be injected directly into the soil or that may press another fluid, e.g. liquid to be injected in the soil. Another example is a system comprising an inner portion, e.g. piston, slideably mounted in an outer shaft and connected with the head 104. Upon impact of the soil with the head, the inner portion slides into the outer shaft and fluid in the outer shaft is injected via the head into the soil. The fluid reservoir than is formed by the space between the inner portion and the outer shaft. Pressurization of the fluid can be increased by providing a spring so that the force by which the inner portion slides into the outer shaft is enlarged. The spring may be mechanically or electronically actuated upon impact. It is an advantage of embodiments according to the present invention that the fluid injector can be mechanically self-activated upon or during impact, thus assisting in additional reliability. Alternatively or in addition thereto, a pressure measurement using a pressure sensor may be used for electronically activating the fluid injector upon or during impact of the penetrometer with the soil.

In a fourth particular embodiment, the present invention relates to an impact device 100 as described above, combining the fluid injector 120 with the mechanical shape of the head. The head 104 of the impact device 100 may comprise a needle-shaped portion wherein fluid openings are provided that are in connection with the fluid reservoir. Upon impact, fluid can be injected in the soil from the opening in the needle-shaped portion. Alternatively or in addition thereto, fluid openings also may be present in the base portion 108 of the head 104 of the impact device 100. The latter may be particularly useful to further improve penetration of the impact device. Combining both techniques also may increase the life-time of the needle-shaped portion. The holes in the needle shaped portion may be spread equally over the needle-shaped portion 106, mainly at the end first penetrating the soil or mainly at the end closest to the base portion 108.

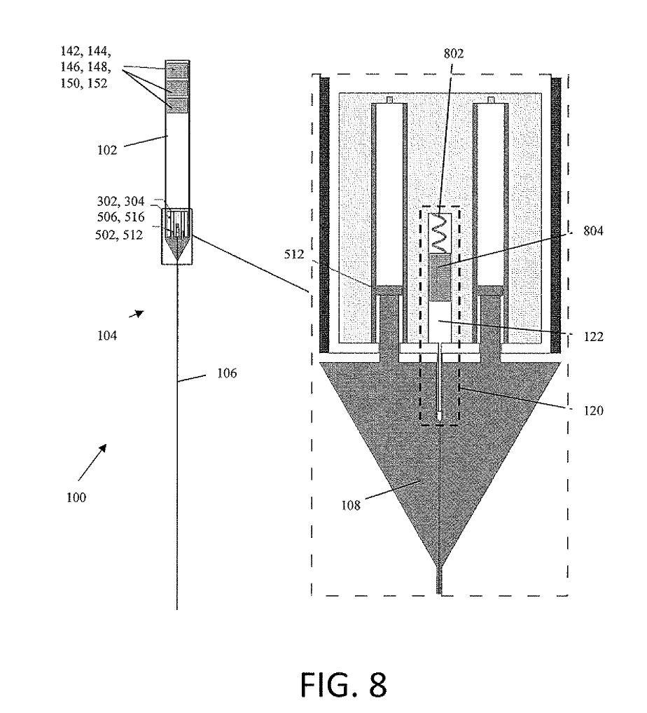

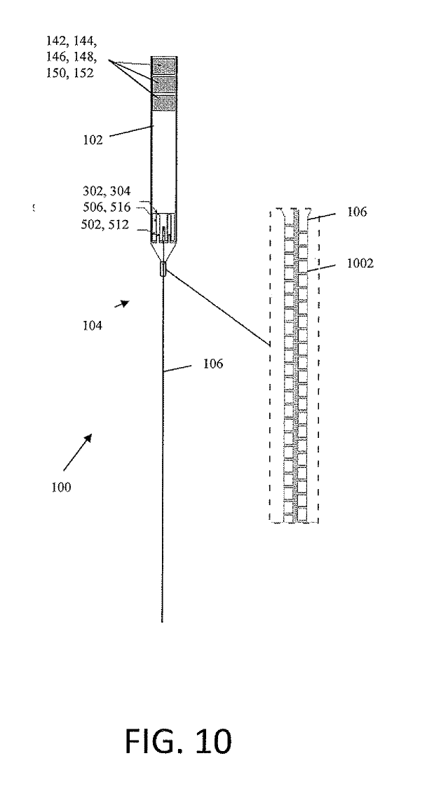

By way of illustration, examples of the third and fourth particular embodiments are shown in FIG. 8, FIG. 9a, FIG. 9b and FIG. 10. FIG. 8 illustrates an impact device with no separate sensor for the needle-shaped portion 106 and with a fluid injector 120 comprising a spring 802 and a piston 804 mounted thereon for boosting up the pressure on the fluid in the fluid reservoir 122 upon impact, as also discussed above.

FIG. 9a and FIG. 9b illustrate a similar setup, but the position of the fluid reservoir 122 is different, so as to allow a larger fluid reservoir 122 and consequently a larger amount of fluid for injection in the soil structure. Whereas FIG. 9a illustrates an embodiment whereby no separate pressure sensor is present for measuring the impact on the needle-shaped portion 102, FIG. 9b illustrates an embodiment whereby a separate pressure sensor is provided for measuring the impact on the needle-shaped portion 102. It can be seen that different channels are used for the channel for pressure measurements and the channel for fluid injection and that fluid injection can be introduced in the needle-shaped portion based impact devices without too much interference from the fluid injection system with the other components. FIG. 10 illustrates a similar setup as shown in FIG. 8, but shows an enlarged view of the needle-shaped portion comprising fluid openings 1002 for injecting the fluid into the soil structure through the needle-shaped portion 104.

By way of illustration, the present invention not being limited thereto, the systems and methods can be applied for different applications. In one application, the systems and methods can be applied for measurement of density of mud layers for determination of the nautical bottom of waterways. The density can for example be measured based on a differential pressure measurement with two distant pressure sensors on board. Besides density also shear stress and viscosity could be parameters to determine e.g. if a ship can still navigate through a sudden mud layer. Shear stress can be measured on the sleeve of the impact device and viscosity can be derived out of the deceleration and the shear stress. It is to be noticed that embodiments of the present invention also may include free fall penetrometers equipped for performing the differential pressure measurement as indicated above, while the free fall penetrometers do not comprise the needle-shaped portion as described above. In other words, the embodiments of the present invention also relate to free fall penetrometers characterized by a means for differential pressure measurements and for deriving therefrom density or other parameters. In another application, measurement of additional parameters like strength of the soil, bearing capacity and pore pressure can be determined and may serve other applications. These parameters may be used in off shore engineering projects and research on slope stability and sediment mobilization. Another application, as described further, is the identification of different material layers based on measuring deceleration curves for identification of minerals like sand.

In a second aspect, the present invention relates to a data processor for processing data to determine presence or absence of a sand layer in a soil structure, advantageously for use with an impact device 100 as described in the first aspect, although the invention is not limited thereto. The data processor according to embodiments of the present invention is adapted for receiving information regarding penetration of or removal from within a soil structure obtained with an impact device adapted for penetrating into a sand layer and for processing the received information for determining presence or absence of a sand layer in the penetrated soil structure. Embodiments of the present invention may relate to a data processor being on board or being partly on board of the impact device 100, although the data processor also may be located outside the impact device 100. The data processor may comprise a two or more processing components, some being present on board, some being present off board. The data processor may be implemented in hardware as well as software. The data processor may for example include a particular software-processing program implemented on a general purpose processor such as for example CPU or an application specific processor such as an DSP, ASIC, FPGA, etc. The data processor may be provided with an input port for receiving raw data, partly processed data or processed data from a sensor in the impact device 100. The input port may be adapted for receiving the data based on USB-technology, serial bus interface technology, Ethernet technology, wireless technology, etc. As indicated above, the data processor is adapted for processing the received information for deriving the presence or absence of a sand layer. In some embodiments a type of soil structure may be determined. The processor therefore may for example comprise a means for deriving deceleration information, e.g. a deceleration profile, for the impact device 100 and a means for deriving based thereon a fingerprint of the soil structure that has been measured. The fingerprint of the soil structure may be representative for the type of layers present in the soil structure. The processing means may be adapted for taking into account a deceleration behavior due to a mechanical shape of the head 104 of the impact device 100 comprising a needle-shaped portion 106 and a base portion 108, a deceleration behavior due to injection of fluid from the head into the soil upon impact, etc.

Detection of sand based on the deceleration profile may for example be established for use of an impact device 100 with needle-shaped portion, when a low amount of deceleration of the impact device is noticed in the initial portion of the deceleration profile, stemming from penetration of a needle-shaped portion 106 into a sand layer, followed by an abrupt deceleration of the impact device 100 stemming from impact of the base portion 108 of the head 104 of the impact device 100. By way of illustration, the present invention not being limited thereto, fingerprints of other types of soil structures are identified in the examples, provided below.

The particular deceleration of a needle-shaped portion is based on the fact that in embodiments of the present invention the diameter of the head of the impact device is of the same order of magnitude as the grain size of the medium that is to be investigated. It is also an advantage of embodiments of the present invention that the pressure contact surface between the medium to be studied and the head is limited. If fluid injection is used, the latter may assist in reducing inter-granular tension between grains that are physically—mechanically—interacting, resulting in a reduction of shear forces and pressure resistance. Upon reduction of these forces and resistance, the resistance for penetration of the device lowers.

As the surface of the interaction between the head and the medium, e.g. sand, in embodiments of the present invention is small, the number of interacting particles, e.g. grains, from the medium is small. In embodiments where fluid injection is used, due to the small number of particles, it is sufficient to inject a small amount of fluid to induce a large effect. The latter is advantageous as this limits the amount of fluid required, and the volume of the fluid reservoir.

According to embodiments of the present invention, the characteristic size of the head may be of the same order as the diameter of the grains in the medium, e.g. sand, so that the medium does not behave as a static block, but acts as a plurality of individual grains, resulting in a lowered resistance for penetrating.

Furthermore, based on the deceleration profile or similar information, the thickness of e.g. a sand layer present in the soil structure may be determined. Information regarding presence of the same type of soil structure or different type of soil structure may be obtained by obtaining different measurement data sets by probing a plurality of times at different positions, or e.g. by combining the information received by probing with an impact device 100 according to the first aspect with other techniques, allowing to detect similar soil structures. The data processor furthermore may be adapted for receiving positioning information regarding the impact device during measurement and for coupling the position information to the information regarding the type of soil structure. By combining geographical soil structure information or by combining different sets of measured and determined soil structure information, a volume of sand being present in the soil structure may be derived. The deceleration profile may be established based on pressure sensor information, accelerometry data and/or shear resistance data. Features and advantages corresponding with features of the impact device 100 also may be obtained. The data processor furthermore may be adapted for combining obtained information from impact measurements with other alternative soil analysis data, such as for example data obtained by acoustic screening.

In a third aspect, the present invention relates to a system for detecting sand positioned under water. The system 200 may comprise at least one impact device 100 as described the first aspect of the present invention and/or embodiments thereof and a data processor as described in embodiments of the second aspect of the present invention. Similar features and advantages as set out in these aspects may be present in embodiments of this third aspect of the present invention. The present invention also relates to a system for detecting sand positioned under water wherein at least two impact devices 100 are provided, at least one thereof being an impact device as described in the first aspect of the invention, the impact devices being adapted for simultaneous use and for acting as a sender respectively receiver in a resistive, acoustic or electromagnetic measurement.

In a fourth aspect, the present invention relates to a method for detecting sand positioned under water. The method may be performed using an impact device (100) as described in the first aspect, although the method is not limited thereto. The method comprises the steps of bringing an impact device 100 comprising a needle-shaped portion having an average diameter between 0.5 mm and 5 mm and a more broad base portion of the head in free fall condition under the water surface, thus inducing, upon impact with soil under the water surface, penetration into a soil structure using an impact device comprising a head adapted for penetrating a sand layer, and, obtaining information, upon penetration of or upon removal from the soil structure, for identifying whether the penetrated soil comprises a layer of sand. The method is particularly useful as, due to the possibility of penetrating sand layers, the sand layers or covered sand layers can be more accurately detected. Inducing penetration into a soil structure using an impact device comprising a head adapted for penetrating a sand layer may be performed in a plurality of ways. It may comprise inducing penetration using an impact device comprising a head with a needle-shaped portion and a base portion, it may comprise inducing penetration using an impact device comprising a concave shaped head, it may comprise a step of injecting fluid from a fluid reservoir in the impact device via the head of the impact device into the soil, or it may comprise a combination thereof. Such a combination may for example comprise injecting a fluid from a fluid reservoir in the impact device through openings in a needle-shaped portion of the head of the impact device into the soil. The method furthermore may comprise, after said obtaining information for identifying whether the penetrated soil comprises a layer of sand, identifying whether or not a layer of sand was present. The latter may be obtained by processing the obtained information. Such processing may comprise receiving sensor data, partly processed sensor data or processed sensor data from the impact device, deriving a deceleration profile or similar information and determining based on said deceleration profile or similar information whether or not a sand layer was present. The latter may e.g. be performed by comparing the deceleration profile or part thereof with a predetermined profile that is considered a fingerprint for the presence of a sand layer and determining whether or not the profile fits the fingerprint within a predetermined error range. By way of illustration, a predetermined profile for presence of a sand layer, if for example use is made of an impact device with needle-shaped portion, may indicate a low amount of deceleration of the impact device upon initial impact, stemming from penetration of a needle-shaped portion with the sand layer, followed by an abrupt deceleration of the impact device stemming from a base portion of the head of the impact device impacting on the sand layer. As the impact device, e.g. the length of the needle, the shape of the base portion, the injection of fluid or not, will influence the deceleration profile, the above processing of information advantageously takes into account a deceleration behavior due to a mechanical shape of the head 104 of the impact device 100 comprising a needle-shaped portion 106 and a base portion 108, a deceleration behavior due to injection of fluid from the head into the soil upon impact, etc.

The method furthermore can comprise additionally capturing one or more of a chemical signal, a pressure signal, a resistive measurement signal, an acoustic backscatter measurement signal, a shock and ultrasonic test signal, an optical backscatter measurement signal or an electromagnetic backscatter measurement signal. In some embodiments, the method may comprise simultaneously using more than one impact device and using the impact devices as sender and receiver in a resistive, acoustic or electromagnetic measurement. The latter may provide complementary information allowing further improving detection of sand layers. For example, detection of such signals may allow deciding that on positions neighboring the impact position on the soil, a similar soil structure is present. Alternatively or in addition thereto, the method also may comprise repeating the impact probing at different positions, so as to be able to derive information regarding the soil structure of an area. The method furthermore may comprise capturing position information regarding the position of the impact device and coupling the corresponding position information to the soil structure information obtained with the impact device. The latter allows for geographic mapping of the soil structure.

In further aspects, embodiments of the present invention also relate to computer-implemented methods for performing at least part of the methods for detecting sand under water as described above, for processing obtained information for identifying sand under water as described above or to corresponding computing program products. Such methods may be implemented in a computing system, such as for example a general purpose computer. The computing system may comprise an input means for receiving data, partly processed data or processed data from the impact device and a processing means for processing the obtained data in agreement with the above method. The system may be or comprise a data processor as described in the second aspect. The computing system may include a processor, a memory system including for example ROM or RAM, an output system such as for example a CD-rom or DVD drive or means for outputting information over a network. Conventional computer components such as for example a keyboard, display, pointing device, input and output ports, etc also may be included. Data transport may be provided based on data busses. The memory of the computing system may comprise a set of instructions, which, when implemented on the computing system, result in implementation of part or all of the standard steps of the methods as set out above and optionally of the optional steps as set out above. Therefore, a computing system including instructions for implementing part or all of a method for detecting sand or processing obtained information is not part of the prior art.

Further aspect of embodiments of the present invention encompass computer program products embodied in a carrier medium carrying machine readable code for execution on a computing device, the computer program products as such as well as the data carrier such as dvd or cd-rom or memory device. Aspects of embodiments furthermore encompass the transmitting of a computer program product over a network, such as for example a local network or a wide area network, as well as the transmission signals corresponding therewith.

By way of illustration, the present invention not limited thereto, an example of how different types of layers can be detected using an impact device comprising a needle-shaped portion 106 and a base portion as described in the first particular embodiment are provided below. In the present example, the obtained information is based on resistance measurement results and/or accelerometry results and sensing of resistance, pressure or deceleration of the needle-shaped portion occurs and is measured discrete from that of the base portion. It is to be noticed that this setup is only selected by way of illustration, the invention not being limited thereto.

If for example a layer of mud is probed using an example impact device 100 according to the first particular embodiment of the present invention, the needle-shaped portion 106 penetrates the mud and feels resistance that is gradually increasing when penetrating deeper. When the base portion 108 penetrates the mud, a sensor feels almost no resistance while the sleeve feels a stronger resistance.

If a layer of sand covered by a layer of mud is probed using an example impact device 100 according to the first particular embodiment of the present invention, the impact device 100 initially acts as in mud, but when reaching the sand layer, the needle-shaped portion 106 penetrates and will feel a similar resistance as in mud but the origin of it is pressure on the top of the needle. Important is that the needle shaped portion 106 penetrates. When the base portion 108 reaches the sand layer, it will not penetrate but immediately stop. The sand layer thus roughly gets its signature by identification of penetration of the needle-shaped portion 106 whereby the needle-shaped portion 106 itself has no significant increase of contribution to deceleration, whereas the base portion 108 has a sudden and strong contribution to the deceleration of the impact device.

If a layer of dense clay is probed, in such dense clay (such as Yperian clay) the impact device 100 will touch the soil structure with the needle-shaped portion 106 and the shear resistance on the needle-shaped portion 106 will significantly increase during penetration. It will be a linear function related to the surface of the needle-shaped portion 106 being subject to friction with the clay. The base portion 108 may or may not reach the clay and will react similar as the needle-shaped portion 106. Depending upon the stiffness of the clay the deceleration curve will change its steepness.

If a layer of pure sand is probed, the needle-shaped portion reaches the sand whereby sand has almost no shear resistance. It is to be noticed that if shear resistance would be there, water injection using additional features from the second particular embodiment could reduce it to almost zero. The needle shaped portion 106 contact with the sand makes almost no contribution in the deceleration, and the pressure sensor connected to the needle-shaped portion will sense the contact with the sand and record the contribution to the deceleration. When the base portion reaches the sand, it will abruptly decelerate. The combination of the pressure sensor on the needle shaped portion and the deceleration sensor together with the pressure sensor on the base portion in this example results in obtaining a signature of sand.

If a layer of sandstone is probed, the needle shaped portion 106 touches the sandstone and breaks or decelerates or the pressure on the needle shaped portion is at its maximum. The base portion will act as on sand or hard clay: high deceleration, high contact pressure on the base portion.

If a layer is probed that consists out of sandy clay and clay sand mixture, the needle shaped portion penetrates the sandy clay but shows the signature of a clay and similar behavior will be seen when the base portion touches the medium.

In a further aspect, the present invention relates to a computerized system for obtaining information regarding a waterway. Such information may for example be a nautical bottom level, although other information such as for example a soil type or a soil structure or information related thereto also may be obtained. The computerized system may be a system comprising an input means for receiving accelerometer data from an accelerometer positioned on an impact device, e.g. free fall device like a free fall penetrometer. Such input means may be adapted for receiving the data in real time, quasi real-time or from a storage. The system furthermore comprises a processing means or processor, being programmed for deriving, based on the accelerometer data, at least one of a density, a viscosity or a depth of a soil. In advantageous embodiments, also a shear stress may be derived. The processor may be any type of processor such as a general purpose processor programmed to perform this derivation or a specific purpose processor designed for performing such derivation. It may e.g. be a microprocessor, an FPGA, . . . . Based on the derived one or more of these properties, a characteristic parameter such as a nautical bottom level, a soil type or a soil structure can be determined. It is an advantage of embodiments according to the present invention that such characterisation can be performed during a continuous single falling path of the free fall object.

As indicated above, the computerized system comprises a processor. According to embodiments of the present invention, the processor is adapted for determining a nautical bottom level, a soil structure, a soil type, etc. The processor as described above may comprise a means for deriving, from acceleration data and optionally one or more pressure, acoustic, resistive and other physical and chemical information from impacting a mud layer, information about the waterway. The processor may be adapted for detecting, based on the received information, a deceleration of the impact device stemming from penetration into a mud layer and related dissipated energy due to shear stress and pore pressure. The processor may be adapted for detecting, based on the received information, the density of the mud layer stemming from penetration into a mud layer. The processor may be adapted for detecting, based on the received information, the depth of mud layers with a sudden density stemming from penetration into a mud layer. The data may be adapted for detecting, based on the received information, the depth of mud layers with a sudden shear strength stemming from penetration into a mud layer. The data processor may be adapted for detecting, based on the received information, the depth of mud layers with a sudden resistivity stemming from penetration into a mud layer.

The data processor may furthermore comprise a means for coupling position information regarding a position of the impact device impact device to the information regarding the type of soil structure obtained with the impact device.

The computerized system may be integrated in a free fall impact device, or in other words embodiments of the present invention also relate to a free fall impact device comprising such a computerized system. Alternatively, the computerized system also may be separate from the free fall impact device, and may for example typically be positioned on a ship or on shore during the free fall impact measurement.

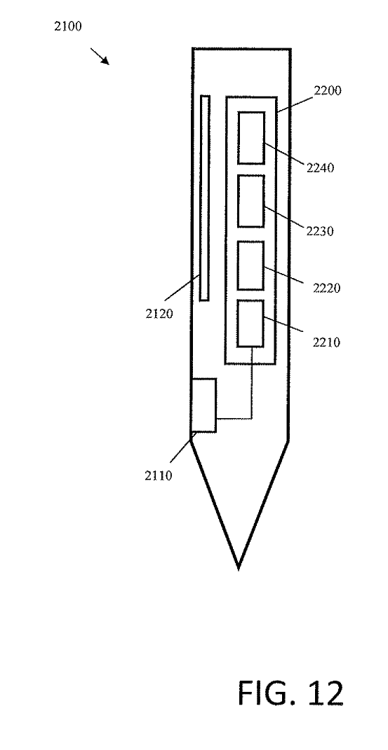

By way of illustration, an exemplary system according to one embodiment of the present invention is shown in FIG. 12. FIG. 12 provides a schematic representation of a free fall impact device 2100, comprising at least one accelerometer 2110 and a computerized system 2200 comprising at least an input means 2210 for receiving data comprising at least accelerometer data and a processor 2220 for deriving properties or characteristics based on the received data. The computerized system 2200 furthermore optionally also may comprise a memory 2230 for receiving data from at least one sensor device and for storing said data, and/or an output means 2240, such as for example any of an output port, a network connection such as a wireless network connection, etc. The impact device furthermore may comprise an interface for connecting to a computing and/or displaying device once the impact device is recovered from under the water surface.

The free fall impact device also may comprise one or more further sensors 2120. Examples of sensors that may be provided are pressure sensors in the head, pressure sensors in the tail, optical and/or mechanical sensors, arrays of optical and/or mechanical sensors, resistance sensors, arrays of resistance sensors, additional accelerometers, shear stress sensors, differential pressure sensors, etc. A number of such sensors is discussed with reference to particular embodiments, which can be combined with other embodiments of the present invention, such combinations herewith also being envisaged within the present invention. Typically one of more of these sensors may be integrated and may be adapted for sensing, during free fall or upon impact with the soil under water, parameters for determining e.g. physical characteristics of the waterway, e.g. underwater sediment layers. The impact device furthermore may comprise a control means for controlling the speed, spin and torque of the free fall impact device.

In one embodiment, the system may comprise at least a first and second impact device, wherein at least one of the first and second impact device is an impact device as described above and wherein the first and second impact device are adapted for simultaneous use and are adapted for acting as a sender respectively receiver in a resistive, acoustic or electromagnetic measurement.

By way of illustration, embodiments of the present invention not being limited thereto, and without being bound to theory, an example of how properties can be derived from data in one particular example will be further explained below. It is to be noticed that the formalism used is only one example of the principles that can be used according to embodiments of the present invention.

According to embodiments of the further aspect of the present invention the free fall impact device comprises at least one accelerometer. Measurements of deceleration and/or acceleration can be obtained using the accelerometer. In one embodiment, by integrating accelerometer measurement data over time also speed of the free fall Penetrometer can be determined and further, by integration of speed over time also position can be determined.

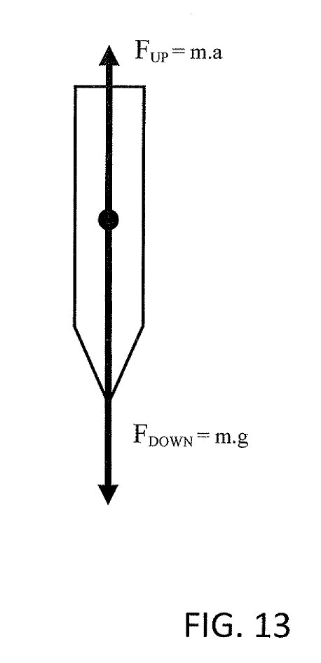

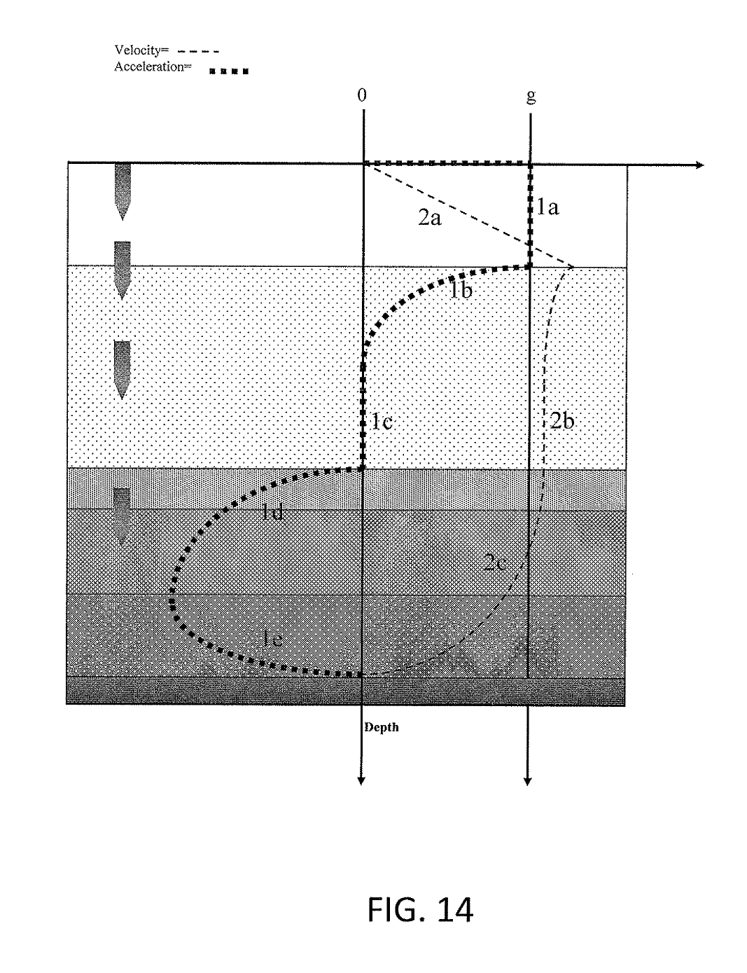

FIG. 13 is illustrating the forces that are working on an free fall impact device in a fluid. The downward force is the gravity. The upward force is a combination of buoyancy force and the drag force that are opposite to the gravity. FIG. 14 is illustrating the behavior of the free fall impact device in a mud layer under water starting from the launch above water. When holding the impacting device before launch the acceleration and speed are zero. Once releasing the impact device the acceleration in air is 1 g (1a in figure) and the speed is linear increasing (2a in figure). When impacting the water, the upward force is increasing strongly and the impacting device is decelerating (1b in figure). Under water there is the upward buoyancy force and the drag force that are opposite to the gravity. The drag force is depending on the speed of the impact device and at a sudden speed the buoyancy and drag force will compensate the gravity and the net force on the impact device is zero (1c in figure). At that moment the device has reached its terminal velocity (2b in figure). At the moment the impact device reaches the mud layer the deceleration is increasing strongly (1d in figure). The speed of the impact device is decreasing (2c in figure) and the related drag force too. Due to the reducing drag force, the deceleration reaches a maximum and decreases till zero (1e in figure).

According to one embodiment, based on the acceleration, speed and position parameters derived based on accelerometer measurement data, the energy balance equation of the free fall Penetrometer can be solved, e.g. taking into account the processes described in FIG. 12 and FIG. 13. In what follows, the fluid sediment is considered to be a Newtonian fluid, which is an approximation. This approximation nevertheless provides sufficiently accurate results on derived parameters such as density. Consequently, density and other parameter referred to in the description refer to Newtonian fluid behavior. At the starting point, which is a drop level above the water the free fall impact device has a sudden potential energy. By dropping the free fall impact device, potential energy is transferred in to kinetic energy. At the moment of impact with the water surface the free fall Penetrometer is decelerated. This level of impact can be determined as the starting point of the depth measurements. Once under water the free fall Penetrometer accelerates till it reaches the terminal velocity Vₜₑᵣₘᵢₙₐₗ. The terminal velocity of an object underwater is given by

Vₜₑᵣₘᵢₙₐₗ=(m−ρV)g/b,

where m is the mass of the penetrometer, ρ is the density of the intruded fluid, g is the gravitation constant, b is the drag coefficient.

The energy balance equation at every small track with length h of the free fall path is given by

½mvᵢₙ²+mgh−½mvₒᵤₜ²+Eₗₒₛₛ.

During the free falling path the falling object is using the potential energy to generate kinetic energy and to compensate for losses.

At terminal velocity the kinetic energy is constant since the speed is constant. Therefore the energy generated by the change in potential energy is fully dissipated. When the free fall Penetrometer decelerates there is more energy dissipated then the change in potential energy. There are three type of losses on the falling object that can be taken into account.

There are three type of losses on the falling object expressed in [J].

First we have losses that are caused by displacement of fluid during the falling path. These losses are determined by the formula E_{buoyancy}=E_{buoyancy}=ρ.V.g.h where ρ is the density and V the volume, g the earth acceleration and h the falling height.

The second type of losses is the drag loss. The drag loss can for example be determined on 3 ways.

First if the speed of the falling device is low the drag loss is determined by laminar flows and hence determined by the formula E_{drag}=b.v.h where b is a drag coefficient at low velocity (i.e. at low Reynolds number), v is the speed of the falling object and h is the falling height. The drag coefficient b is a unique parameter of the falling object and the drag coefficient is assumed to be constant over a sudden medium. During the falling process the different medium layers can be identified on the deceleration curve. On each medium layer an experimental drag coefficient will be used in the calculation. The use of the drag coefficient can be avoided in the equations by replacing the drag losses by shear stress losses.

Second if the speed of the falling object is high then the drag losses are caused by turbulent flows and are determined by the following formula E_{drag}=½.ρ.A.C_{d}.v².h where ρ is the density, v is the speed of the falling object, A is the surface of the falling object, C_{d} is the drag coefficient at high velocity (i.e. at high Reynolds number) and h is the falling height. A and C_{d} are characteristics of the falling object and therefore important in the determination of the density or viscosity. The drag coefficient C_{d} is a unique parameter of the falling object and the drag coefficient is assumed to be constant over a sudden medium. During the falling process the different medium layers can be identified on the deceleration curve. On each medium layer an experimental drag coefficient will be used in the calculation. The use of the drag coefficient can be avoided in the equations by replacing the drag losses by shear stress losses.

Third way to determined the drag loss is via the shear stress on the sleeve of the falling object and is determined by the formula E=τ.A.h where τ is the shear stress and A is the surface of the following object sleeve and h is the falling height.

In advantageous embodiments of the present invention, specific characteristics of the free fall impact device are taken into account in the processing for deriving one or more of a density, viscosity or depth. Typical characteristics of the free fall impact device that may be taken into account by the processor and that may be provided as input to the input means may be one or more of the mass, the side surface (sleeve surface) of the free fall impact device, the diameter of the free fall impact device, a surface area of the head of the free fall impact device, a volume of the free fall impact device, etc.

The third type of losses on the free falling object is the pore pressure that can be build up on the penetrating point of the falling object (=head of the object). This pore pressure is often omitted in the calculations but can be taken into account if an additional pressure sensor is foreseen in the head of the falling object. The power dissipated on the head can be derived from the measured pressure on the head by p.A₁.v, where A₁ is the surface of the head, p is the cone pressure due to additional pore pressure and v is the speed of the free fall penetrometer. Out of the equation Eₗₒₛₛ=E_{drag}+E_{displacement}=ρ.V.g.h+½.ρ.A.C_{d}.v².h the density ρ can be determined and once ρ is set al the other parameters can be derived like shear stress τ and viscosity.

The computerized system and/or free fall impact device according to the further aspect may comprise additional components performing at least a part of the method steps described in the method aspect of the present invention or a particular embodiment thereof.

In another aspect, the present invention also relates to a method for obtaining information about a waterway. Obtaining information may for example comprise detecting the nautical bottom level under water, but also may include determining a soil structure or a soil type. The method according to embodiments of the present invention comprises receiving accelerometer data from an accelerometer of a free fall object and deriving, based on the accelerometer data at least one of a density, a viscosity or a depth of a soil. Additionally also shear stress may be determined. Receiving accelerometer data may comprise receiving accelerometer data via an input port based on measurements done in a remote free fall impact device or via an input means in direct connection with the accelerometer for an integrated computerized system. Receiving accelerometer data may for example comprise bringing an impact device comprising at least an accelerometers and advantageously also one or more of pressure sensors and shear stress sensors in free fall condition under the water surface, and inducing a deceleration due to impact on a mud layer under the water surface. The method also may comprise obtaining, upon penetration in mud layer, based on acceleration information, the kinetic energy, speed, position, shear stress and pore pressure for determining information of the waterway such as the nautical bottom in said sediment, a soil or mud structure, etc. The method also may comprise capturing one or more of a chemical signal, resistive measurements signal, acoustic backscatter measurement signal, a shock and ultrasonic test signal, an optical backscatter measurement signal and an electromagnetic backscatter measurement signal and based on these signals calculate the nautical bottom. The method further also may comprise obtaining position coordinates associated with the position of the impact device and coupling the position coordinates with information regarding the soil structure obtained with the impact device. The method furthermore also may comprise simultaneously using a second impact device and using the impact devices as sender and receiver in a resistive, acoustic or electromagnetic measurement.

In one embodiment, based on the acceleration, speed and position parameters, the dynamic equation of the free fall impact device can be solved. The dynamic equation of a free falling object under water is:

$$m \frac{{d}^{2} y}{d {t}^{2}} = ( m - ρ V ) g - B \frac{d y}{d t} where \frac{{d}^{2} y}{d {t}^{2}} and \frac{d y}{d t}$$

are the acceleration and the velocity of the free fall impact device. The density ρ and drag coefficient b are both parameters dependent on the intruded sediment type or mud type. The equation can also be set by replacing −bdy/dt by the high speed drag force ½.ρ.A.v².Cd in case the free fall object reaches higher speeds.

In order to determine the density of the mud layers in an alternative manner, e.g. as cross check, for confirmation or for fine tuning, additional methods can be applied, typically making use of additional sensors. Consequently, several additional sensors can be integrated in the free fall impact device. First way to measure density via a free fall impact device is to integrate two pressure sensors. One sensor is located close to the head of the free fall impact device and one is integrated close to the tail of the free fall impact device on a fixed distance from each other. Based on the Bernoulli formula the pressure difference gives an indication for the density as follows ρgh+½ρv²+p=constant. When working out the equation at each pressure sensor it shows that ρgh₁+p₁=ρgh₂+p₂ because the fluid speed is constant in each point. This results in

$$ρ = \frac{{p}_{2} - {p}_{1}}{gh}$$

where h is the fixed distance between the two pressure sensors. In one embodiment, the present invention also relates to a system and method for determining a density in a waterway or a soil structure thereof based on this principle. The system and method are adapted for determining density based on a pressure difference between two pressure sensors in a free fall impact device and based on the formula of Bernouilli. The principles also are shown in FIG. 7 whereby two integrated pressure sensors in an impact device are illustrated. The results for this method can show some deviations from other methods since the pressure build up at the sensor will not be purely dependant on the depth and the density of the material but also from other effects like pore pressure. Pore pressure is a local pressure increase due to the sediment grains in the fluid mud that are acting like a local valve and avoiding the water in the mud flowing away at the top of the free fall impact device.

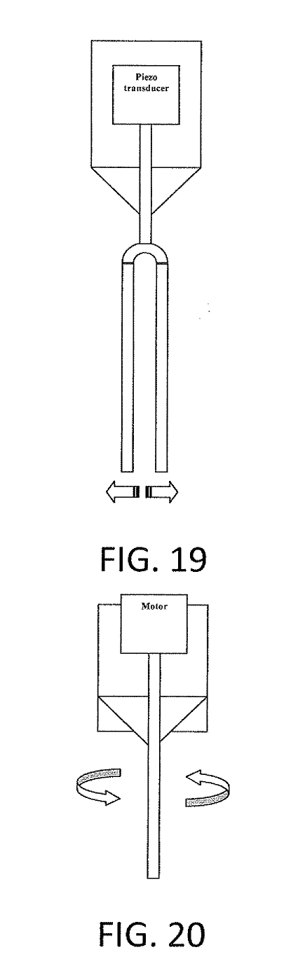

An alternative way to measure the density is via a tuning fork installed on the head of the free fall Penetrometer. The resonance frequency of the tuning fork is shifting dependant on the density variation of the intruded layers. In one embodiment, the present invention also relates to a system and method for determining a density in a waterway or a soil structure thereof based on a resonance shift occurring in a tuning fork of a free fall impact device. The tuning fork may comprise two elongated portions spaced apart from each other and may comprise a processor for monitoring the resonance shift. An example of such a system is shown in FIG. 19.

In some embodiments according to the present invention, the system and method are adapted for determining a pore pressure. By way of illustration, two examples of how pore pressure can be measured are discussed. In one example, the pressure on the head can be measured using a movable head and a pressure sensor. The pressure that is build up on the head of the free fall impact device during the intrusion of a mud layer is a measure for the pore pressure. An alternative system and method for measuring a pore pressure is by using a permeable ring or several openings in the head of the free fall Penetrometer where the water, that is flowing away when mud is suppressed upon impact, can flow in. By this means the pressure of the water in the mud at impact is measured.

An alternative way to measure the shear stress is to introduce a rotating axis during the fee fall. The torque variation due to the friction on the rotating axis is a measure for the shear stress. The torque variation will result in a current variation of the driving motor. This current will be a measure for the shear stress. In one embodiment, the present invention also relates to a system and method for determining a shear strength in a waterway or a soil structure thereof based on a rotating element on the free fall impact device and by monitoring the rotation, e.g. monitoring the motor power of a rotating element. By way of illustration an example of such a system is shown in FIG. 20.

The shear stress can be directly measured by integrating a single or multiple shear stress in the sleeve of the free fall Penetrometer. This sensor can be an optical or mechanical shear stress sensor. The advantage of a having a string of shear stress sensors in the sleeve is the ability to measure the shear stress at different speeds at a sudden point. When the free fall Penetrometer is going through a mud layer it decelerates. At a sudden point a stack of vertical sensor is passing with different speed. So the shear stress is measured at different speeds in one point. Due to the non linear behavior and non-Newtonian behavior of mud the shear stress will be also non-linear over different speeds. Therefore this type of measurements can cover this non linear behavior. In one embodiment, the present invention also relates to a system and method for measuring the shear strength in a waterway or a soil structure thereof using an integrated stack of shear stress sensors, allowing a method wherein monitoring of shear stress is performed in a single point at different speeds.

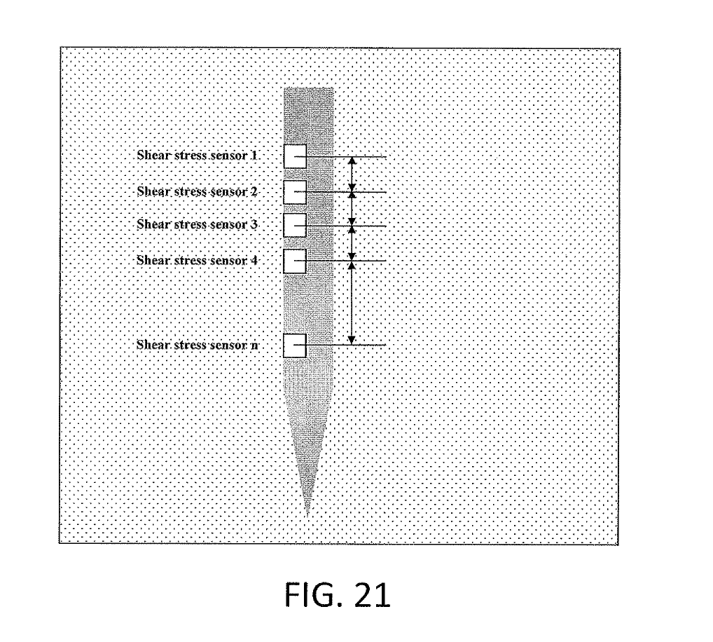

A corresponding system is shown in FIG. 21.

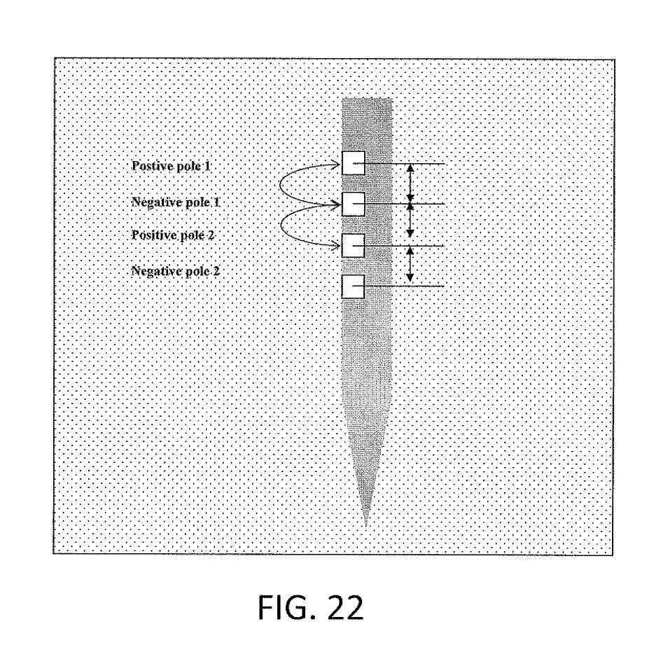

In one embodiment, the present invention also relates to a system and method for measuring a salicity in a waterway or a soil structure thereof. The system is adapted for measuring the electrical resistance between different points along the path of the free fall impact device, e.g. by one electrical resistance sensor or an array of electrical resistance sensors. In FIG. 22 a corresponding system is shown.

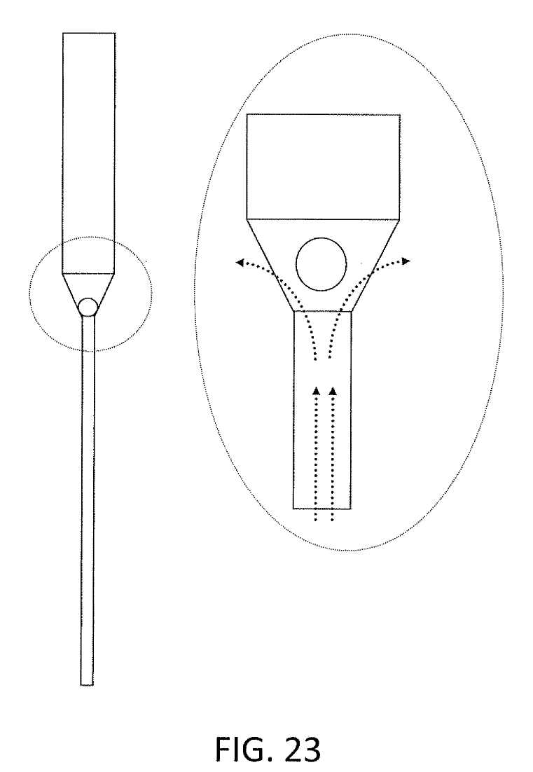

In one embodiment, the present invention also relates to a system and method for obtaining information of a waterway. The system and method thereby is adapted for sampling a sediment during a free fall impact device. The free fall impact device comprises a sampling tube, typically positioned at a top of a free fall impact device. The sampling tube typically may be provided with a valve, so that a sample sediment is not lost when retrieving the free fall impact device from the water. The method comprises launching a free fall impact device, upon impact filling the sampling tube with liquid mud automatically due to the acceleration induced under free falling conditions. After the liquid mud is sampled, the method also comprises automatically closing a valve upon retrieval for assuring that the liquid is not flowing back when pulling out of the mud layer. An example of such a system is shown in FIG. 23.

The method furthermore may comprise method steps corresponding with the functionality of other components described for the system according to the further aspect of the present invention.

In a further aspect, the present invention also relates to a computer program product adapted for, when run on a computer, performing a method as described above. The method may comprise receiving information regarding penetration of or removal from within a soil structure obtained with an impact device adapted for determining the nautical bottom and for processing said received information for determining the nautical bottom in the penetrated soil structure. The computer program product may be adapted for deriving deceleration information, speed, position, shear stress of the impact device and the soil structure and deriving based thereon soil characteristics including any of the nautical bottom, a soil type or a soil structure.

The present invention also relates to a data carrier comprising a computer program product as described above and/or the transmission of such a computer program product over a network.

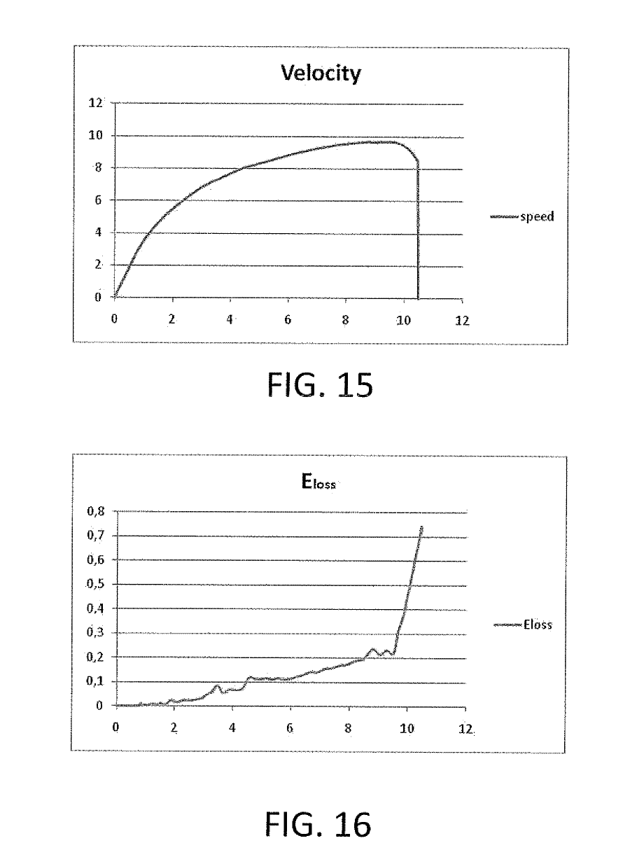

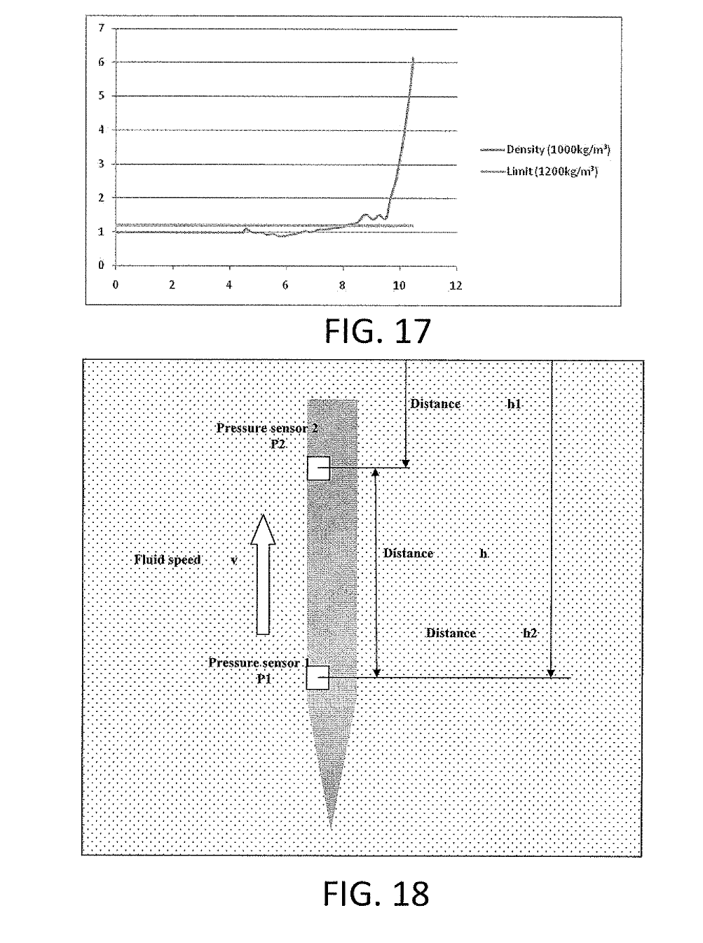

By way of illustration, embodiments of the present invention not being limited thereto, an example of in situ measurements as can be obtained using a free fall impact device according to an embodiment of the present invention is shown with reference to FIG. 15 to FIG. 17. FIG. 15 is the result of an in situ measurement with a free fall Penetrometer with on board accelerometers. The accelerometer is measuring the acceleration or deceleration and by integration the velocity v can be determined. FIG. 15 shows the velocity evolution over de depth of the impacting device. FIG. 16 is the result of the free fall impact device losses for an in situ measurement. The losses are the sum of the shear strength losses of the intruding layers in combination with the displacement losses. FIG. 17 is the result of density for an in situ measurement of the penetrated layers by the free fall impact device. The density is calculated based on the losses via the displacement of the fluid mud by the free fall impact device in combination with the drag losses.

In one exemplary embodiment, a method and system is described adapted for determining the top of a mud layer, by comparison of curves of velocity obtained through pressure measurement and using accelerometers. By way of illustration, an example of an algorithm is further described. Out of a measurement with a pressure sensor the depth can be derived by the formula p=ρ.g.h. By differentiating, the velocity of the penetrometer can be derived. The velocity can also be derived from the integration of the accelerations. Comparing the velocity curve derived from the pressure sensor and the velocity curve derived from the accelerometers, a deviation between the two curves can be observed at the top of the fluid mud layer. The increase of the density of the fluidum generates an increase of pressure on the sensor resulting in an apparent velocity increase, while the increase of the density of the fluidum, according to fluidum mechanics, generates a deceleration of the system. The exact displacement of the system is described by the accelerometers. The difference between the two curves is an indication for the density. FIG. 24 illustrates the two velocity curves determined using accelerometry and pressure sensor measurements.

In another exemplary embodiment, methods and systems are provided wherein the top of a mud layer and the top of a consolidated mud layer is determined using an echosounder and acoustical data. Using particular frequencies, an echosounder can provide details of different soil layers. At a 210 kHz frequency the top of the fluid mud layer is provided. Turbulence can disturb this level and in that case the identification of the top layer with a density variation algorithm can provide a solution. Also the reological transient layer between fluid and consolidate mud can be identified as a variation in the rheology (shear stress and viscosity) and/or density. The consolidated hard layer is detected by a 33 kHz of the echosounder.

In still another exemplary embodiment, a system is provided wherein a free fall penetrometer comprising acoustic sensors is present. Using such a system an acoustic or seismic mapping can be done after penetrating the soil.

In yet another exemplary embodiment, a system and method is provided wherein a correlation is made between a power dissipation and a dredging power. In such embodiments, the energy losses of a free fall penetrometer instrument in different soil layers is correlated with the energy required for dredging up the layers.

In still another exemplary embodiment, a system and method is provided wherein complementary data for CPT sounding is obtained for combining with free fall penetrometer data. Often when soil structures are need to be analyzed under a waterway or canal, there are CPT soundings taken on land next to the investigated waterway and the detected layers are extrapolated to the waterway. The new sediment layers in the waterway can not be derived from the CPT sounding. Therefore a few samples with the free fall Penetrometer in the waterway can complement the CPT sounding data on land.

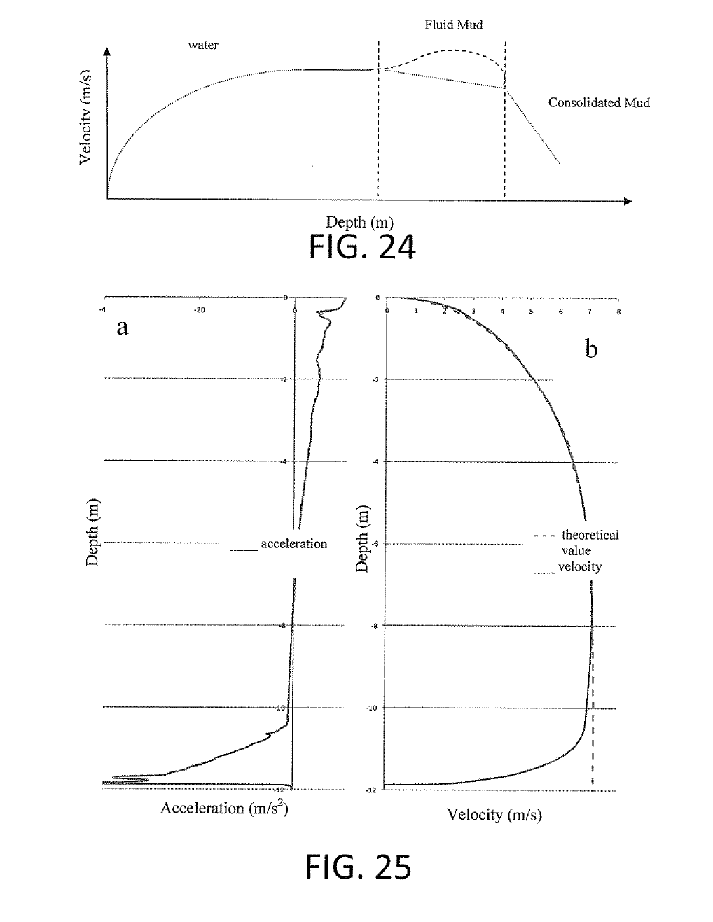

By way of illustration, an example illustrating the use of acceleration measurements according to embodiments of the present invention is now discussed with reference to FIG. 25 to FIG. 27. In FIG. 25(a), the acceleration of the probe is depicted. Out of acceleration velocity is derived as depicted in FIG. 25(b). A theoretical curve is known of a falling object in water. As soon as the theoretical curve is not fitting any more the probe is reaching a layer with higher density, typically the fluid mud layer.

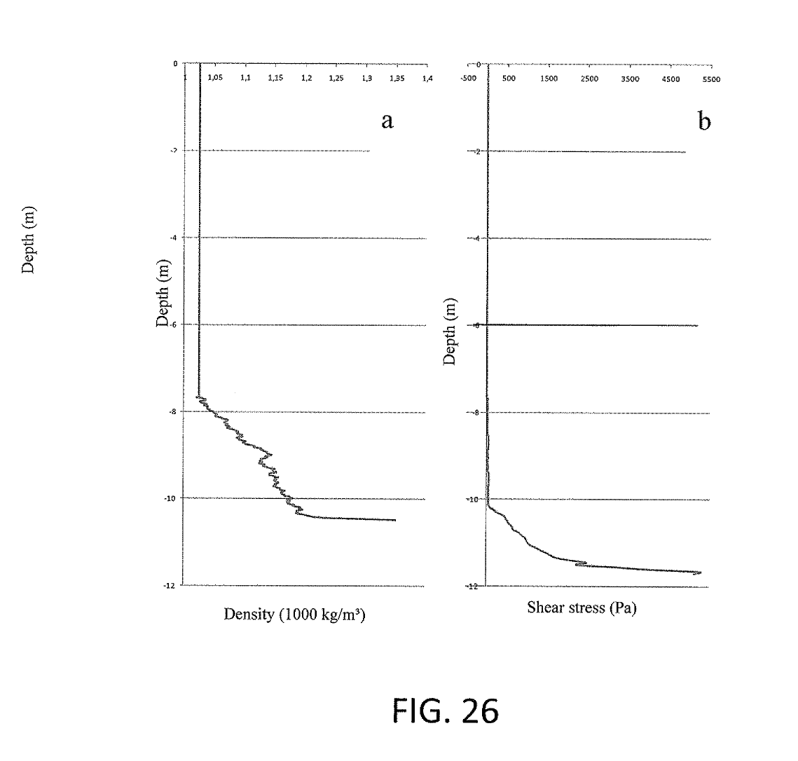

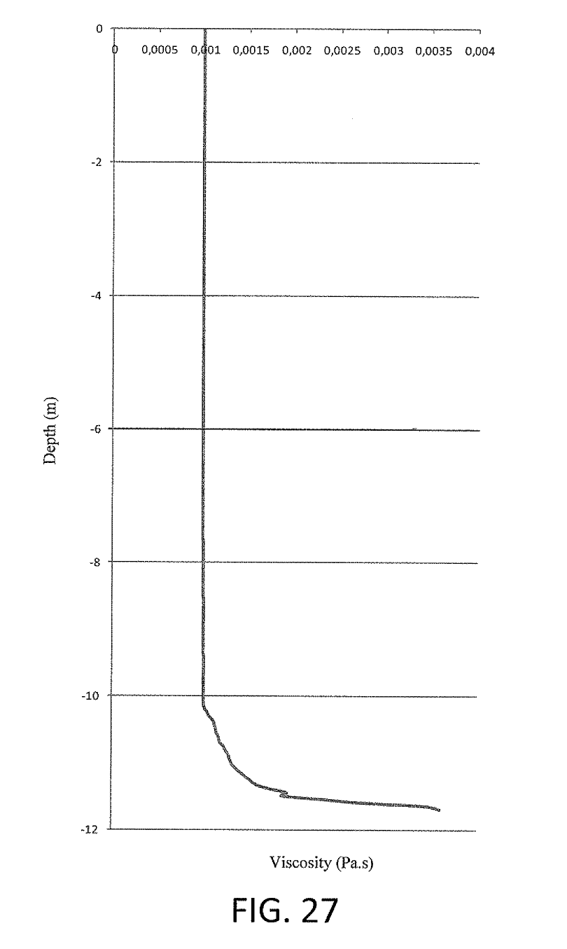

By calculating the losses of the instrument the losses are assigned to different forces. One of the forces is shear stress on the sleeve of the instrument. Out of the losses the shear stress is determined in FIG. 26(b). Also the drag is responsible next to buoyancy for the losses. Out of the drag losses a density is derived with the formula F_{drag}=C_{d}.ρ.v².A in fluid mud. This is depicted in FIG. 26(a). In combination with the pressure sensore the density figure can be made more accurate if the depth is known out of the formula p=ρ.g.h. Out of the speed and the shear stress also viscosity can be derived as depicted in FIG. 27.

While the invention has been illustrated and described in detail in the drawings and foregoing description, such illustration and description are to be considered illustrative or exemplary and not restrictive. The invention is not limited to the disclosed embodiments.

The foregoing description details certain embodiments of the invention. It will be appreciated, however, that no matter how detailed the foregoing appears in text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

1. A computerized system for obtaining information regarding a waterway, the system comprising
an input means for receiving accelerometer data from an accelerometer on a free fall object,
a processing means being programmed for deriving, based on said data accelerometer data at least one of a density, a viscosity or a depth of a soil.

2. A computerized system according to claim 1, wherein the processing means is programmed for deriving the density based on an acceleration/deceleration of the free fall object, the buoyancy force and one or more of a drag force and a pore pressure.

3. A computerized system according to claim 1, the system being adapted for co-operating with or comprising the free fall object and the processing means being programmed for taking into account any of mass information of the free fall object and information regarding at least one dimension of the free fall object, for a free fall object being an elongated object, a side surface along the length of the elongated object for determining the at least one of a density, a viscosity or a depth of a soil, or a diameter of the free fall object.

4. A computerized system according to claim 1, wherein the processing means is programmed for taking into account any or a combination of a volume, length, drag coefficient or friction coefficient of the free falling object.

5. A computerized system according to claim 1, the processing means furthermore being programmed for taking into account a pressure measurement obtained with said free fall object and/or optical or mechanical sensor measurements obtained with said free fall object.

6. A computerized system according to claim 5, wherein a pressure sensor is provided in a head of the free falling object for taking into account a pore pressure on the free fall object.

7. A computerized system according to claim 5, wherein the processing means is adapted for using said pressure or optical or mechanical sensor measurements for cross-checking, compensating or fine-tuning the obtained values of the density, viscosity or depth.

8. A computerized system according to claim 7, wherein the processing means is programmed for deriving a shear stress based on said optical or mechanical sensor measurements and for deriving said density, viscosity or depth based on said shear stress.

9. A computerized system according to claim 1, the system furthermore being adapted for deriving a shear stress.

10. A computerized system according to claim 1, the free fall object comprising an array of optical or mechanical sensors along the length of the free fall object, and the processing means being adapted for deriving a shear stress on the free fall object as function of velocity.

11. A method for obtaining information regarding a waterway, the method comprising
receiving accelerometer data from an accelerometer of a free fall object,
deriving, based on said data accelerometer data at least one of a density, a viscosity or a depth of a soil.

12. A method according to claim 11, wherein said deriving comprises at least deriving the density based on said data.

13. A method according to claim 12, wherein said deriving comprises deriving the density based on the buoyancy force due to displaced volume by the free fall object during its falling path in the liquid.

14. A method according to claim 13, wherein said deriving comprises any of deriving the density based on an acceleration/deceleration of the free fall object, the buoyancy force by the displaced volume and one or more of a drag force and a pore pressure, taking into account mass information and information regarding at least one dimension of the free fall object from which the accelerometer data are obtained, taking into account a side surface along the length of the free fall object used for determining said at least one of a density, a viscosity or a depth of a soil, or taking into account a diameter of the free fall object, or taking into account a surface of the free fall object.

15. A method according to claim 11, wherein said deriving comprises taking into account a pressure measurement obtained with the free fall object and/or optical or mechanical sensor measurements obtained with the free fall object.

16. A method according to claim 15, wherein the method comprises using the optical or mechanical sensor measurements for deriving a shear stress and determining from the shear stress any of the density, viscosity or depth for cross-checking the values of the density, viscosity or depth obtained using the accelerometer data.

17. A method according to claim 11, the method furthermore comprising deriving a shear stress based on the accelerometer data.

18. A method according to claim 11, the method comprising deriving a shear stress as function of velocity based on a single fall experiment of a free fall object.

19. A free fall impact device for obtaining information regarding a waterway, the free fall impact device comprising an accelerometer for determining accelerometer data and a processing means being programmed for deriving, based on said data accelerometer data at least one of a density, a viscosity or a depth of a soil.

20. A free fall impact device according to claim 19, the free fall impact device comprising a computerized system according to claim 1.
